(19) United States
(12) Patent Application Publication
(10) Pub. No.: US 2007/0087446 A1
(43) Pub. Date: Apr. 19, 2007

(54) Aromatic phosphonium salts and their use as labeling reagents in mass spectrometry analysis

(75) Inventors: John C. Gebler, Hopkinton, MA (US); Peter Jeng-Jong Lee, Westborough, MA (US); Weibin Chen, Holliston, MA (US)

Correspondence Address: EDWARDS & ANGELL, LLP, P.O. BOX 55874, BOSTON, MA, 02205, US

(73) Assignee: Waters Investments Limited, New Castle, DE (US)

(21) Appl. No.: 10/553,307

(22) PCT Filed: Apr. 14, 2004
(86) PCT No.: PCT/US04/11426

§ 371 Date: Aug. 7, 2006

Related U.S. Application Data
(60) Provisional application No. 60/462,997, filed on Apr. 14, 2003.

(51) Int. Cl. G01N 24/00

(52) U.S. Cl. 436/173

(57) ABSTRACT

This invention relates to methods and reagents for the assay, detection, quantification, location, or analysis of each of a plurality of substances of interest (“analytes”) in a sample in which each substance is labeled with a cationic triarylphosphonium group. The present invention also provides MALDI mass spectrometry techniques in which the analysis of samples containing low molecule weight analytes is not obscured by matrix components. The invention also provides labeling reagents for use in labeling analytes prior to MS analysis in which the labeled analytes have a molecular weight above the useful detection threshold of MALDI techniques. In some aspects, the invention provides methods of quantitative MS analysis of components of a sample. Methods of the present invention include sensitive techniques for desorption/ionization of molecules at the picomole, femtomole, and attomole amounts. Another benefit of the present invention is that measurement of m/Z values is not complicated by the low-mass interference that a matrix normally offers, and therefore the invention provides methods of MALDI MS analysis of low molecular weight samples as well as mixtures of high and low molecular weight samples.

### RELATED APPLICATIONS

This application claims priority to U.S. Provisional Patent Application No. 60/462,997, filed Apr. 14, 2003, (attorney docket no. WCZ-038-1), the contents of which application are hereby expressly incorporated herein in their entirety by this reference.

### BACKGROUND

Mass spectrometry (“MS”) is an analytical technique in which a sample containing analytes of interest is ionized, for example, by bombardment with high energy electrons. The resulting ions and charged fragments of the parent substance are then focused by electrostatic and magnetic fields to give a spectrum of the charged fragments. MS is routinely used to measure the molecular weight of a sample molecule as well as its fragmentation characteristics. MS is typically carried out in the gas phase in which a sample at low pressure is passed through an electron beam. The electron beam strikes a sample molecule, which typically is electrically neutral, and ejects one or more electrons producing an ion with a net positive charge. The ionized sample is then passed through a magnetic field and, depending on the course of the ionized sample through that field, the mass of the molecule to the ion's electric charge is measured.

Mass spectrometry measures the ratio of the mass of the molecule to the ion's electric charge. The mass is customarily expressed in terms of atomic mass units, called Daltons. The charge or ionization is customarily expressed in terms of multiples of elementary charge. The ratio of the two is expressed as a “m/Z” ratio value (mass/charge or mass/ionization ratio). Because the ion usually has a single charge, the m/Z ratio is usually the mass of the “molecular ion,” or its molecular weight (“MW”). One way of measuring the mass of the sample accelerates the charged molecule, or ion, into a magnetic field. The sample ion moves under the influence of the magnetic field. A detector can be placed at the end of the path through the magnetic field, and the m/Z of the molecule calculated as a function of the path through the magnetic field and the strength of the magnetic field. Another technique for measuring the mass of the sample is time-of-flight (“TOF”) mass spectrometry. In TOF MS, a sample ion is accelerated by a known voltage, and the time it takes a sample ion or fragment thereof to travel a known distance is measured.

Mass spectrometry is usually carried out in the gas phase in which an electrically neutral sample at low pressure is ionized. The simplest mass spectrometers introduce a gaseous, electrically neutral sample in vacuo, normally at pressures of about 10⁻⁶ torr or less. The ionized sample is then passed through a magnetic field and, depending on the course of the ionized sample through that field, the mass of the molecule to the ion's electric charge is measured. Molecules that are not readily put in the gaseous phase, such as proteins, peptides, polymers, and other high molecular weight compounds, are more difficult to analyze by MS. Several techniques exist, however, for volatilizing high molecular weight samples, including desorption ionization techniques.

Instead of starting with a gas phase sample, as in basic MS, desorption MS may be applied to a sample adsorbed on a substrate. When a sample molecule is deposited on a substrate, the sample is said to be adsorbed to that substrate. Desorption occurs when a molecule adsorbed on a substrate is removed from the substrate. One desorption MS technique is matrix-assisted laser desorption/ionization (“MALDI”). In this technique, a sample is deposited on an appropriate substrate and then ionized by transferring a proton from an organic matrix to the sample as part of the vaporization process. Ionization of the sample may be achieved by electron beam ionization or proton transfer ionization. See, e.g., M. Karas, et al., Int. J. Mass Spectrom. Ion Proc. 78, 53-68 (1987); K. Tanaka, et al., Rapid Comm. Mass Spectrom. 2, 151-53 (1988).

In a typical MALDI experiment, a sample is dissolved into a solid, light-absorbing organic matrix that vaporizes upon pulsed laser radiation, carrying the sample with the vaporized matrix. In this manner, high molecular weight samples maybe volatilized for mass spectrometric analysis. Modem MALDI mass spectrometers, such as the LC-MALDIprep™ (Waters Corp., Milford, Mass., USA), permit the sequential high throughput analysis of several samples on one substrate with high sensitivity and reproducibility. Although it is a widely used and powerful technique, MALDI is not generally appropriate for the study of small molecules because the matrix interferes with measurements below a m/Z, i.e., mass to charge ratio, of about 500 to about 700.

### SUMMARY OF THE INVENTION

This invention relates to methods and reagents for the assay, detection, quantification, location, or analysis of each of a plurality of substances of interest (“analytes”) in a sample in which each substance is labeled with a cationic triarylphosphonium group. The present invention also provides MALDI mass spectrometry techniques in which the analysis of samples containing low molecule weight analytes is not obscured by matrix components.

The invention also provides labeling reagents for use in labeling analytes prior to MS analysis in which the labeled analytes have a molecular weight above the useful detection threshold of MALDI techniques. The labeling reagents of the invention may be represented by the formula [Ar₃P⁺R]X⁻, in which each Ar is an aryl group (all of which may the same or different), P is a phosphorous atom, R is a “reactive group;” and X⁻ is a negatively-charged counter ion.

In some aspects, the invention provides methods of quantitative MS analysis of components of a sample. Methods of the present invention include sensitive techniques for desorption/ionization of molecules at the picomole, femtomole, and attomole amounts. Another benefit of the present invention is that measurement of m/Z values is not complicated by the low-mass interference that a matrix normally offers, and therefore the invention provides methods of MALDI MS analysis of low molecular weight samples as well as mixtures of high and low molecular weight samples.

### DESCRIPTION OF THE DRAWINGS

FIG. 1 shows CID spectra. FIG. 1A shows CID spectra of singly charged peptide GMDSLAFSGGL m/Z 1053.5. FIG. 1B shows CID spectra of its TMPP—Ac derivative, m/Z 1626.5. The results illustrate the utility of TMPP—Ac—OSu labeling reagents of the invention in the MS squencing of peptides. See “A Picomole-Scale Method for Charge Derivatization of Peptides for Sequence Analysis by Mass Spectrometry,” Watson, et. al., Anal. Chem. 69, 137-44 (1997); “Charge Derivatization of Peptides to Simplify Their Sequenceing with an Ion Trap Mass Spectrometer,” Adanczyk, et. al., Rapid Commun. Mass Spectrom. 13, 1413-22 (1999). The labeling reagents here may be used to increase sequence coverage (directing fragmentation) and ionization efficency (fixed charge).

FIG. 2 is a summary of results of direct derivatization of tryptic digests (Huang, et al., Anal. Biochem. 268, 305 (1999)). The methods and reagents of the invention may facilitate sequenceing of tryptic digests. See, e.g., “Protein Sequenceing by MALDI-PSD-MS Analysis of the N-Tris(2,4,6-trimethoxyphenyl)phosphine-Acetylated Tryptic Digests,” J. T. Watson, Anal. Biochem. 268, 305-17 (1999) (β-Endorphin, Human GIP, Bovine GHRF, Cytochrome C, Myoglobin, Rabbit G-3PD, BSA, Phosphorylase b, E. Coli, and β-galactosidase); and “Complete Sequencing of Anti-vancomycin Fab Fragment by Liquid Chromatography-Electrospray Ion Trap Mass Spectrometry with a Combination of Database Searching and Manual Interpretation of the MS/MS Spectra,” J. C. Gebler, J. Immunol. Methods 260, 235-49 (2002).

FIG. 2 illustrates the application of the invention to high sequence coverage and straightforward sequence determination of peptides. Increased sequence coverage, increased ionization of hydrophobic peptides, and simplified sample preparation (desalting not necessary) are advantageous features of the invention. The fixed-charge TMPP-dervitized molecules also show improved efficiency for mass analysis because of a higher ion yield, leading to an increase in the detection sensitivity.

FIG. 3 shows a MALDI mass spectrum of the products of the labeling reaction discussed in the Examples.

FIG. 4 is a mass spectrum of TMPP-labeled naphthalenemethylamine (200 fmol, without matrix).

FIG. 5 illustrates the following mixture derivatization reaction: 20 μL of 2 nmole/μL L-alanyl-L-alanine, L-carnosine, L-cysteine, L-asparagine, L-naphthalenemethylamine (in 80%/20% 50 mM triethylammonium bicarbonate/CH₃CN) and 2 μL 130 nmole/μL TMPP—Ac—OSu (in CH₃CN) were mixed and let stand at 50° C. for 90 minutes, after which 1.2 mL 0.1% TFA water solution was added. Then 5 μL of the reaction mixture was mixed with 10 μL matrix (10 mg/mL of CHCA) and 1 μL thereof was spotted onto a standard MALDI plate and analyzed by MALDI-MS. About 10 pmole of target molecules were spotted onto the plate, and no sample clean-up or desalting was necessary.

FIG. 6 is the MALDI mass spectrum of 10 pmole samples described in FIG. 5.

FIGS. 7A, 7B and 8 are a comparison of the MALDI mass spectra of unlabeled (FIG. 7A—full range) and labeled (FIG. 7B—fill range and FIG. 8—zoom) compounds.

FIG. 9 is a mass spectrum of 100 fmol of the derivatizated mixture. This figure illustrates the sensitivity of the method.

FIG. 10 is a mass spectrum of derivatization mixture without matrix.

FIG. 11 illustrates the positive effect of the TMPP label on the ionization of a hydrophobic peptide.

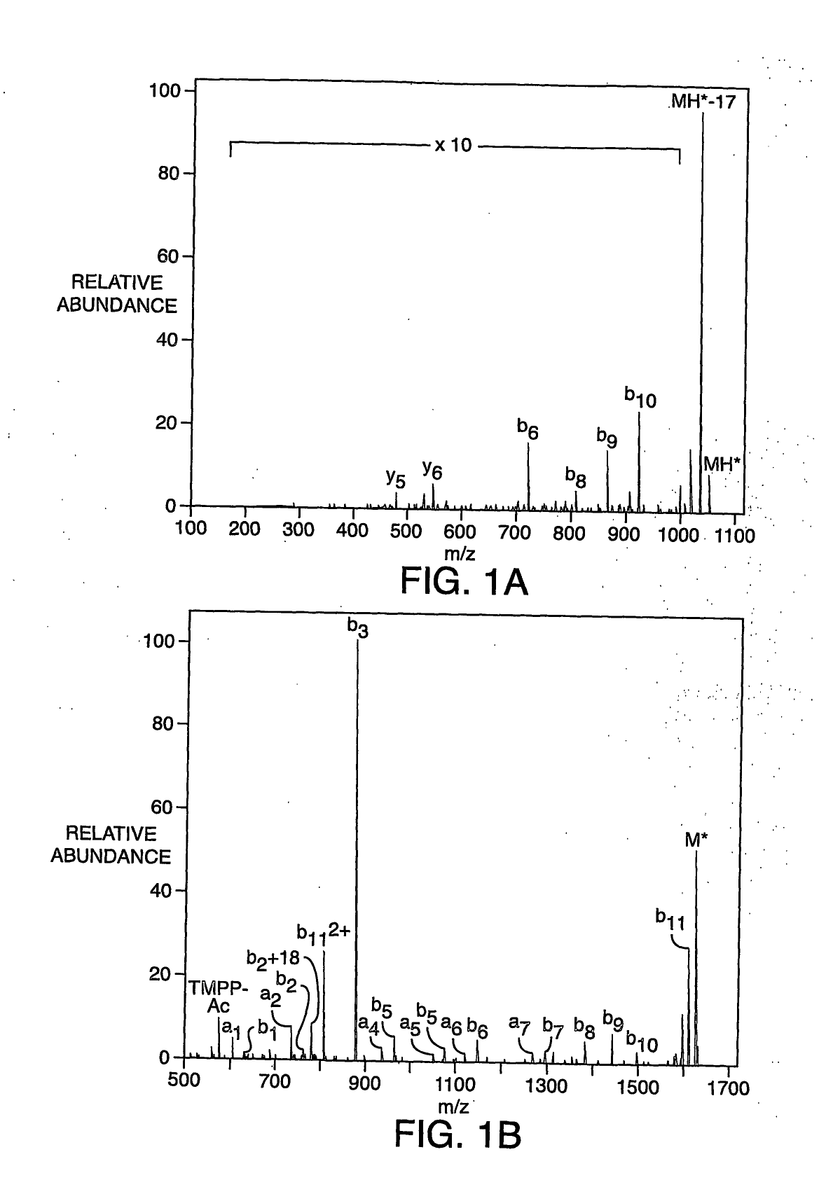

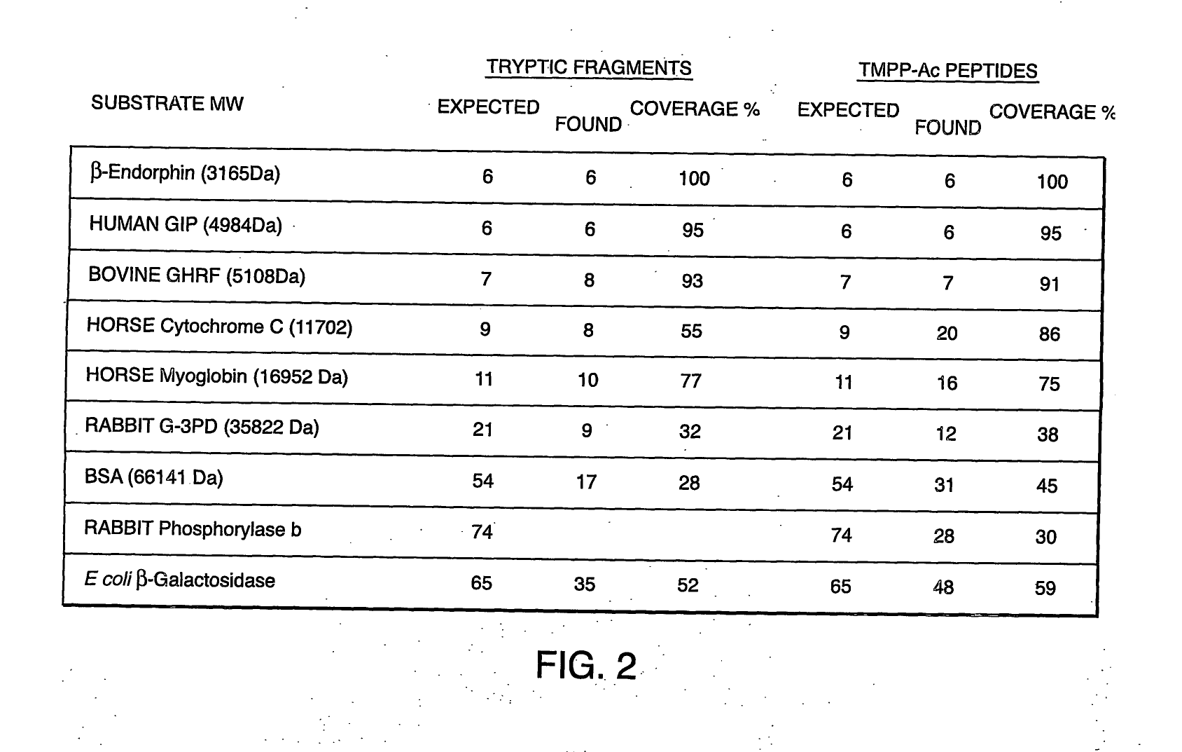

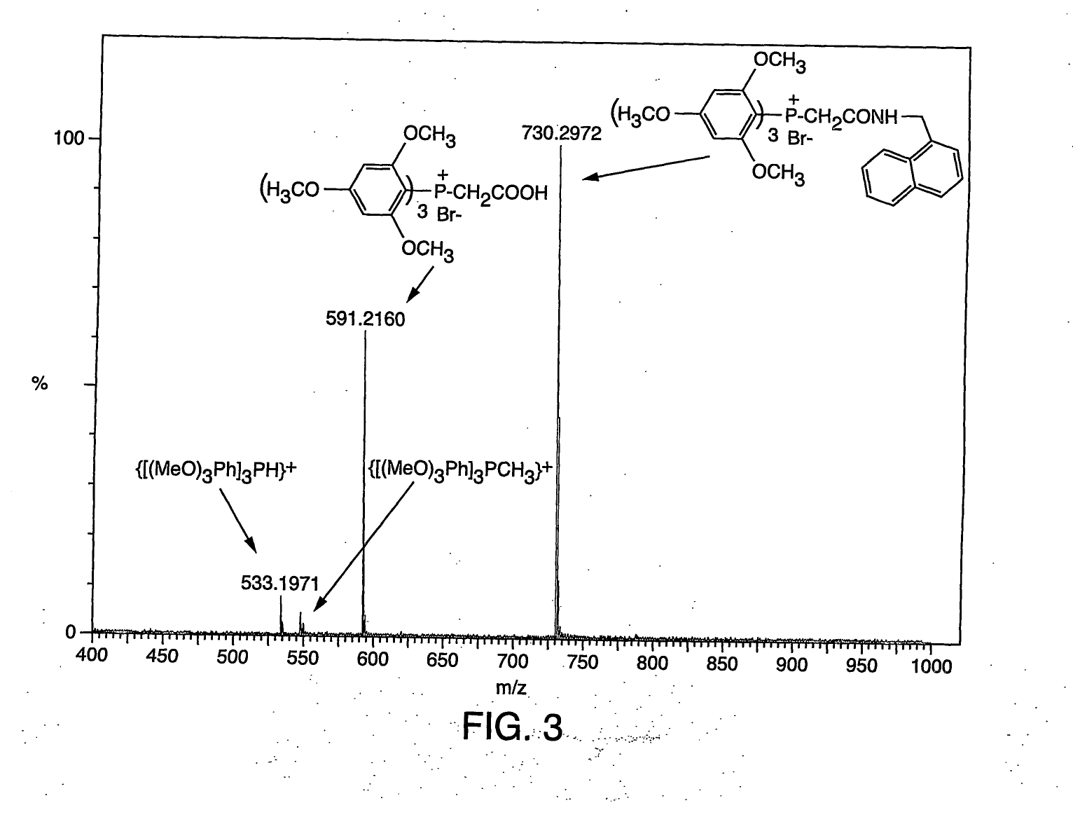

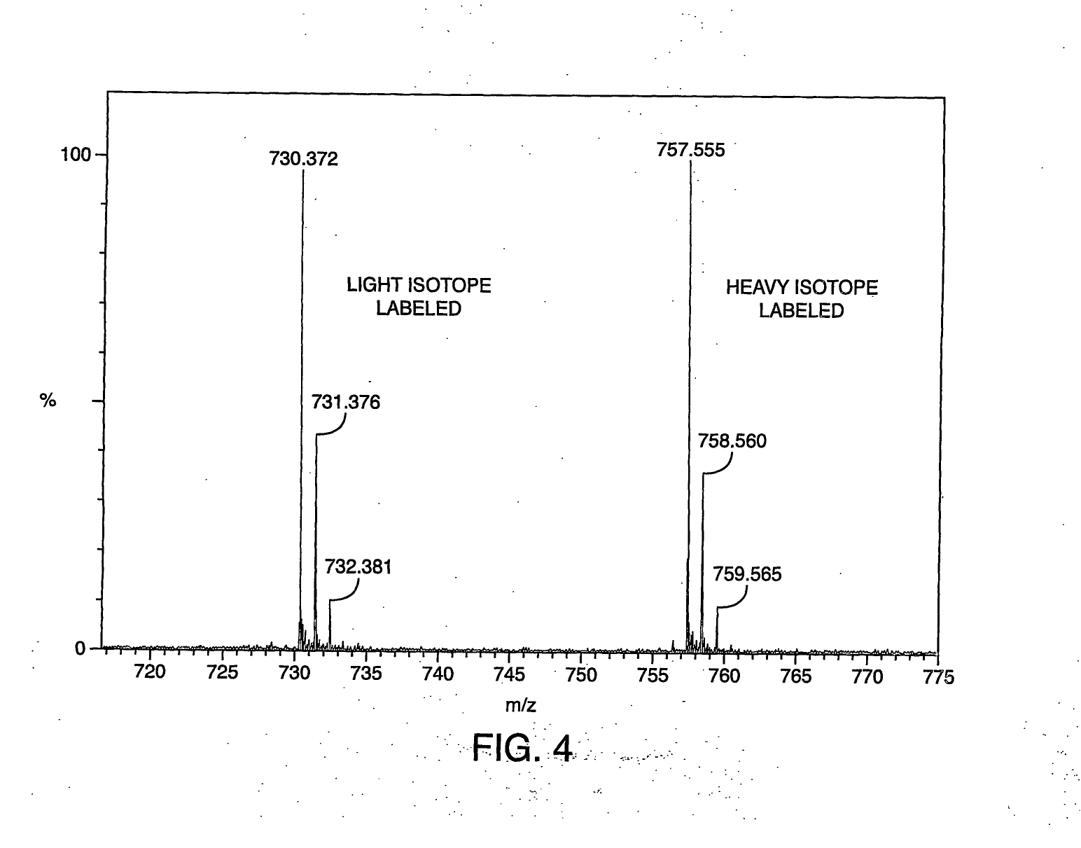

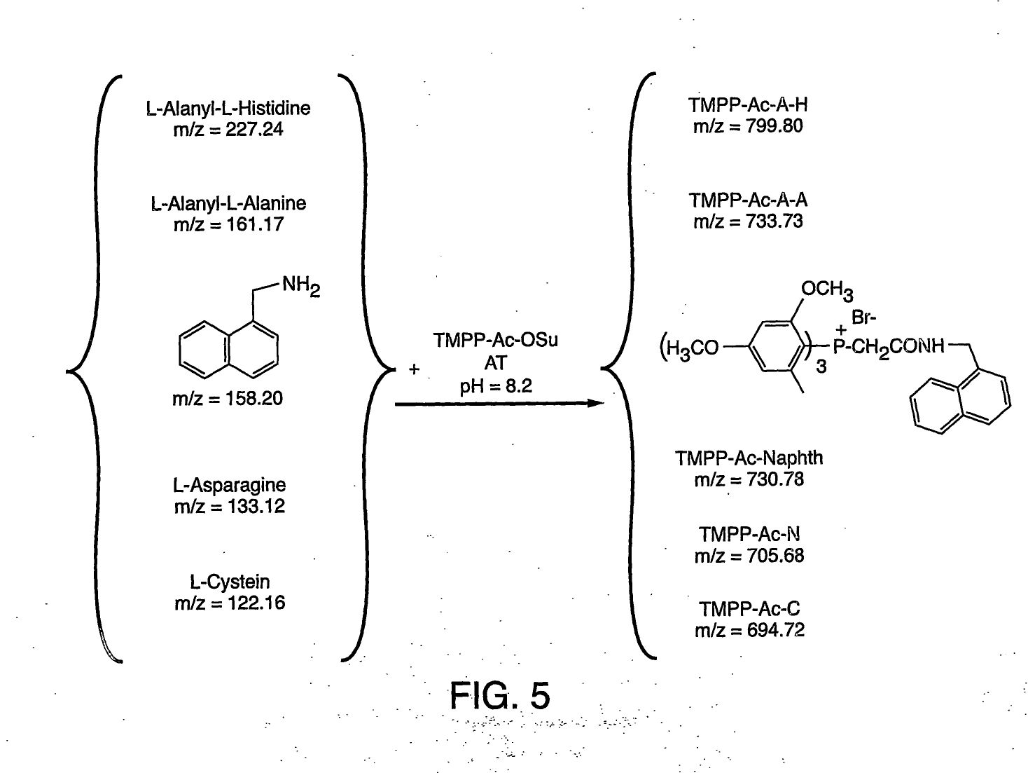

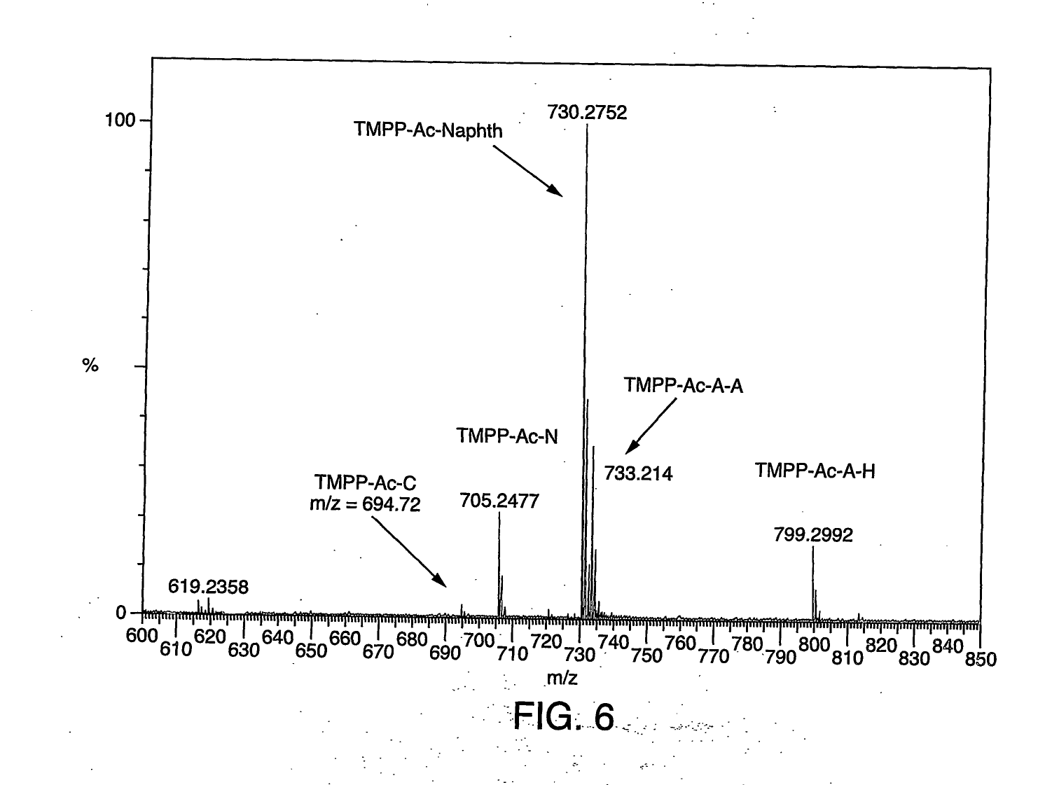

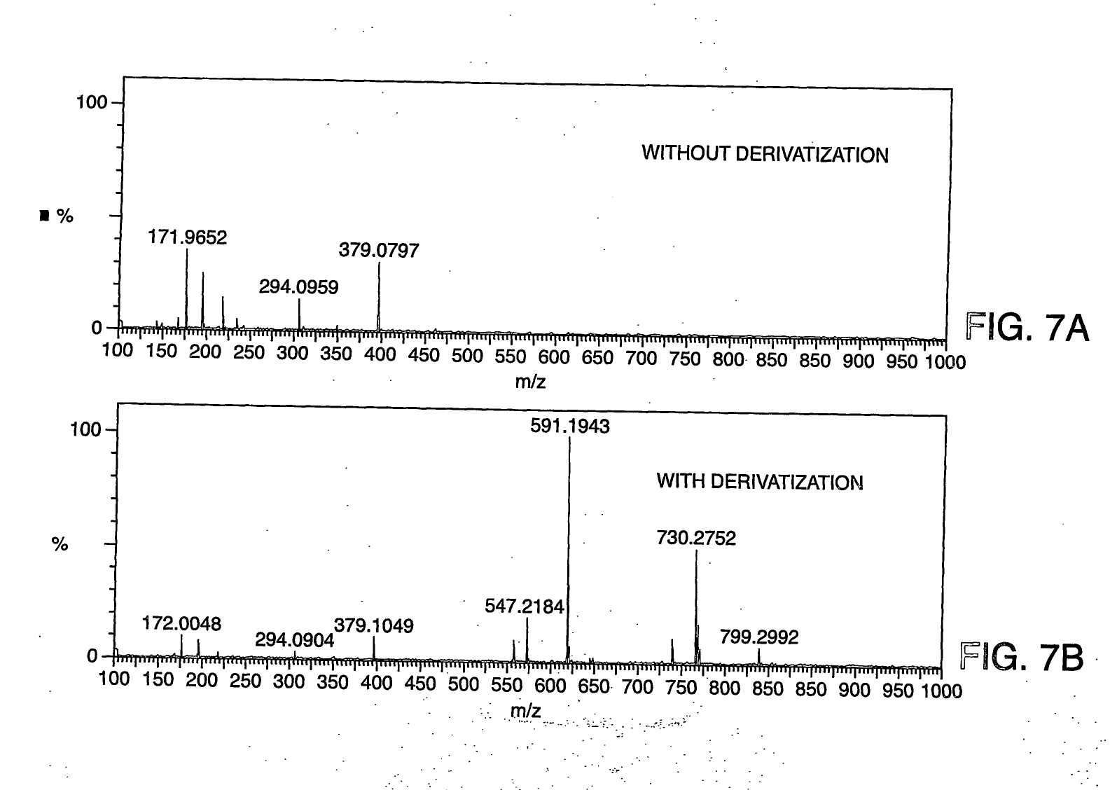

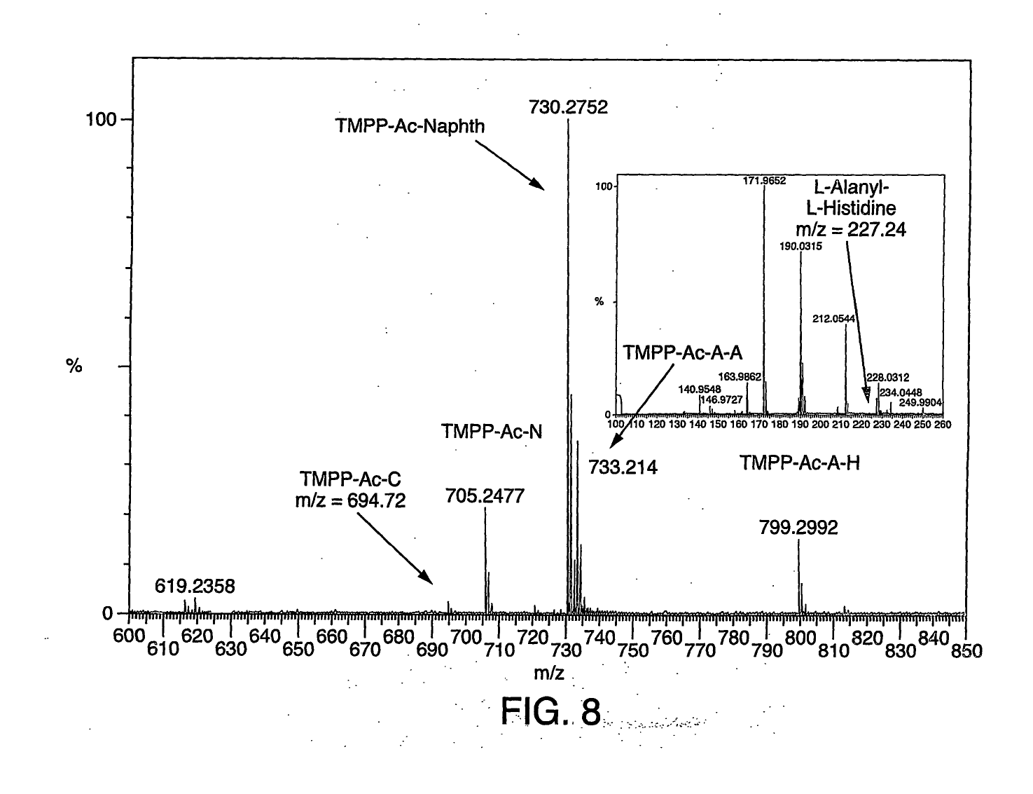

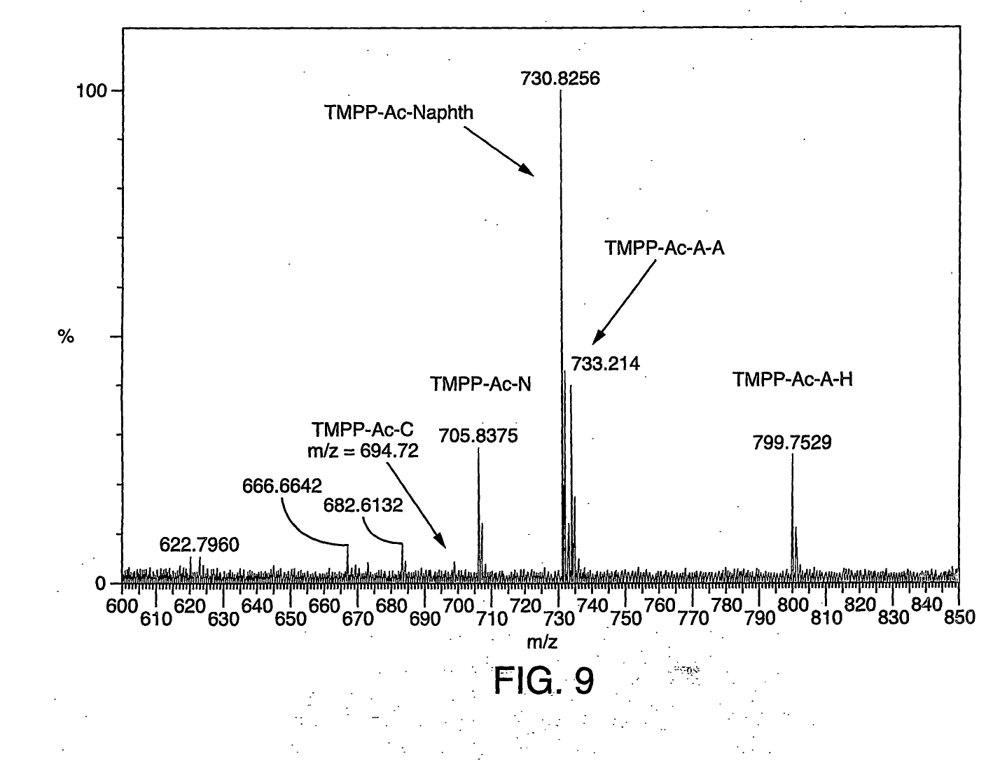

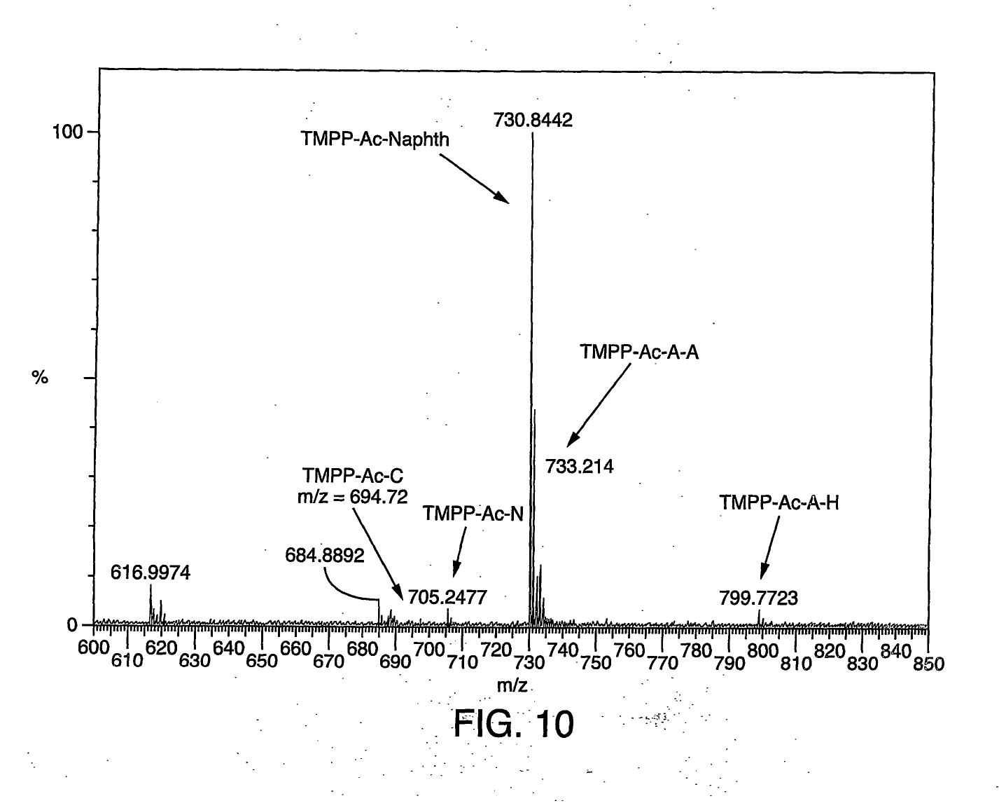

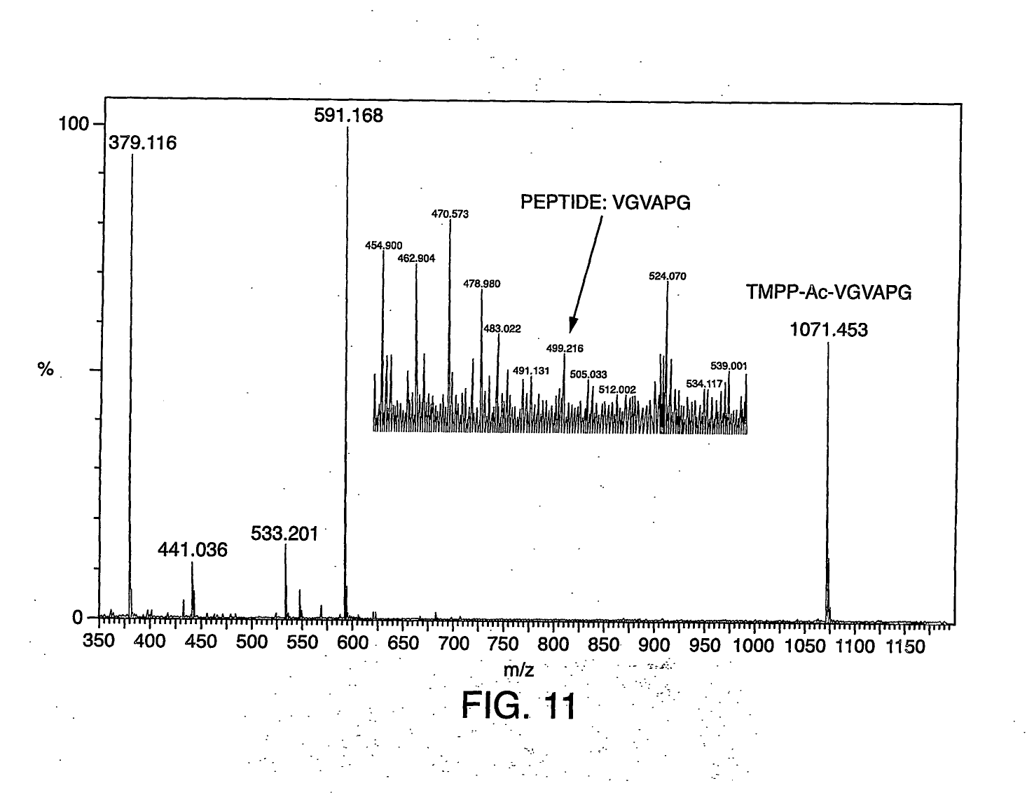

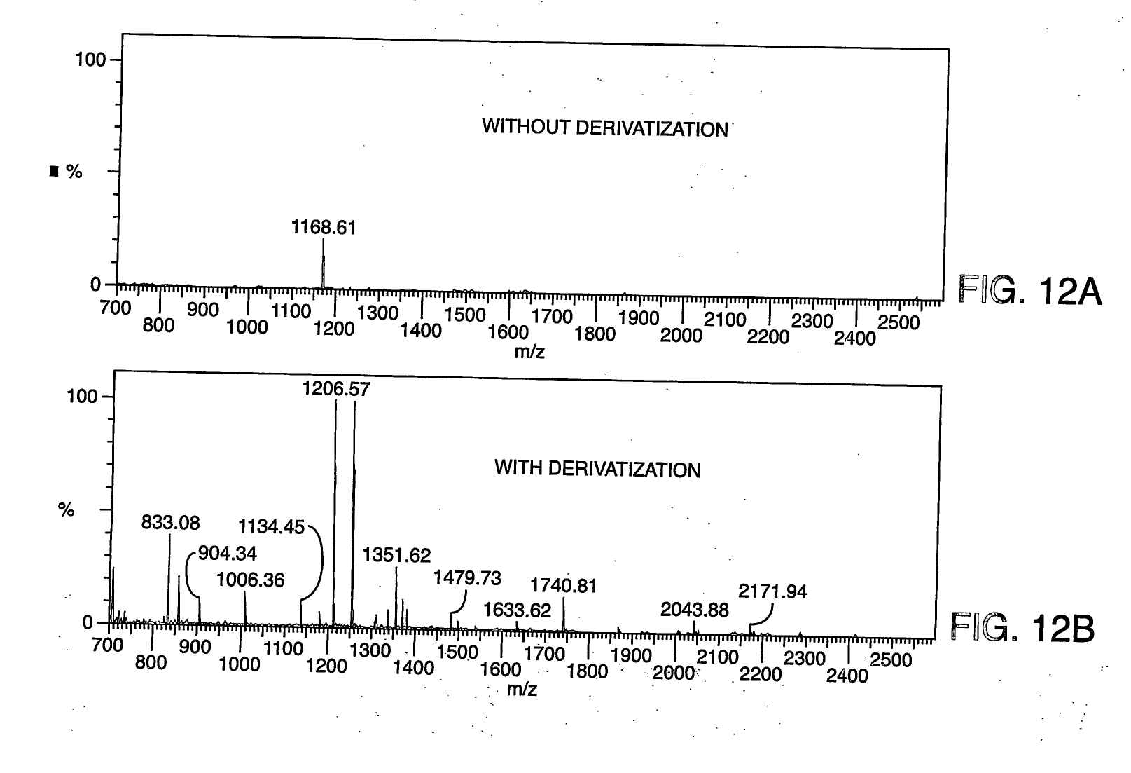

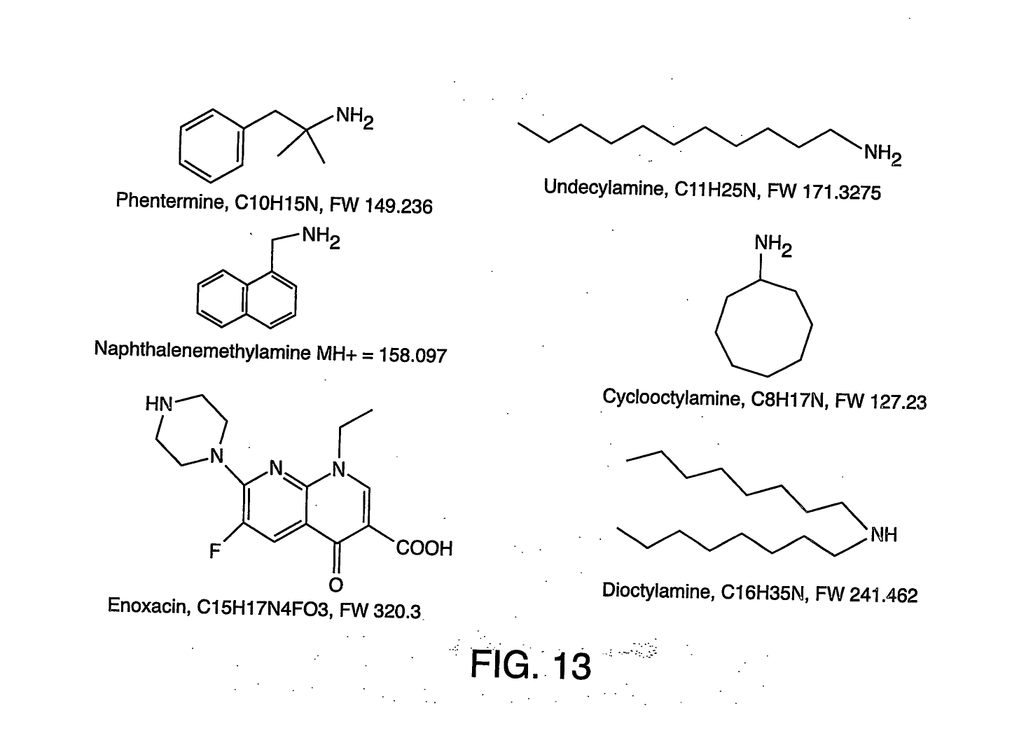

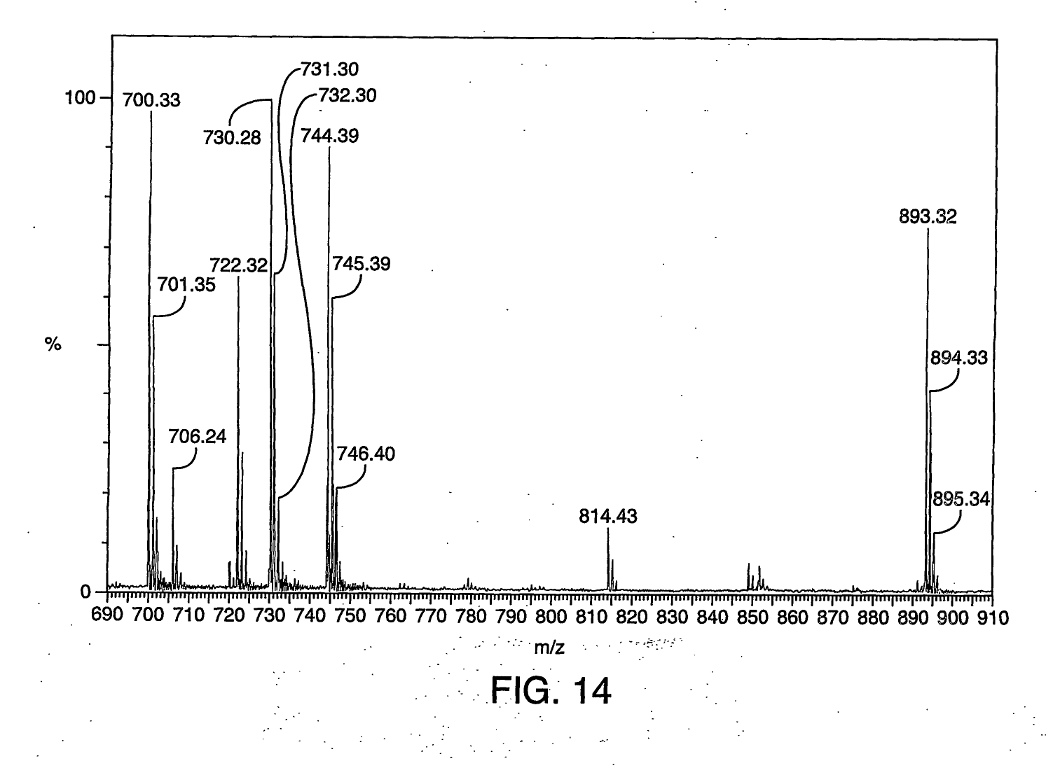

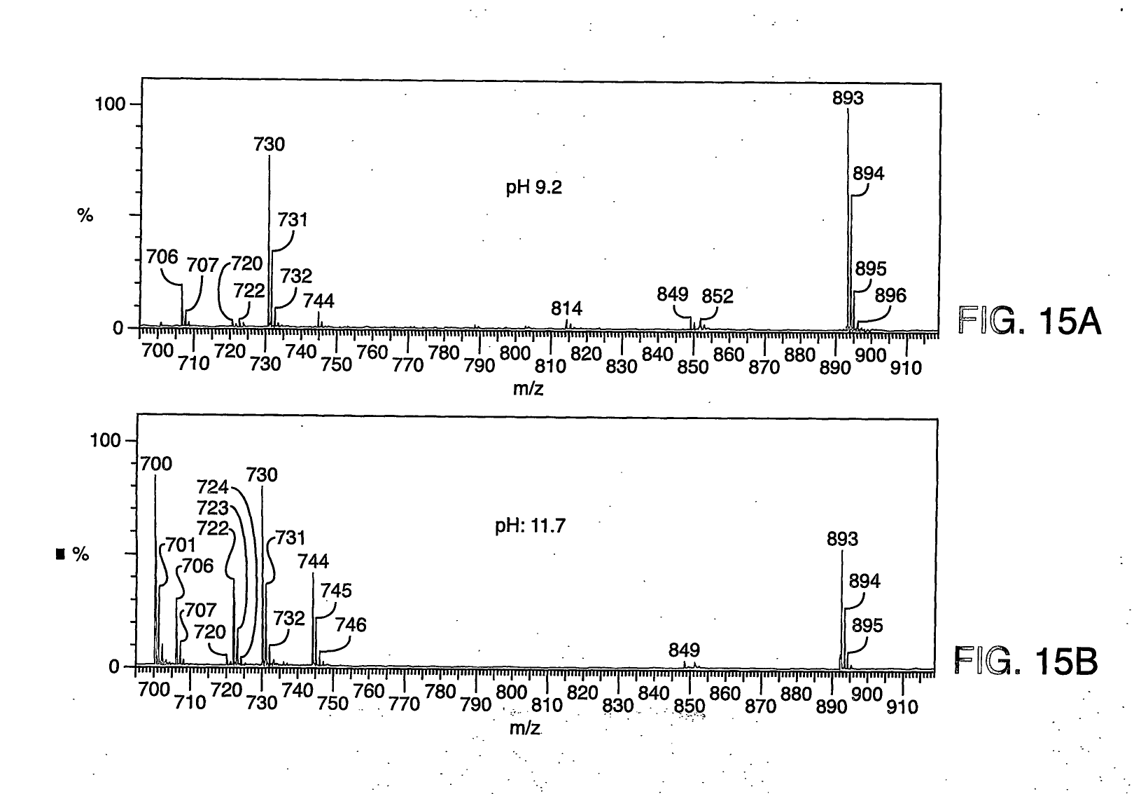

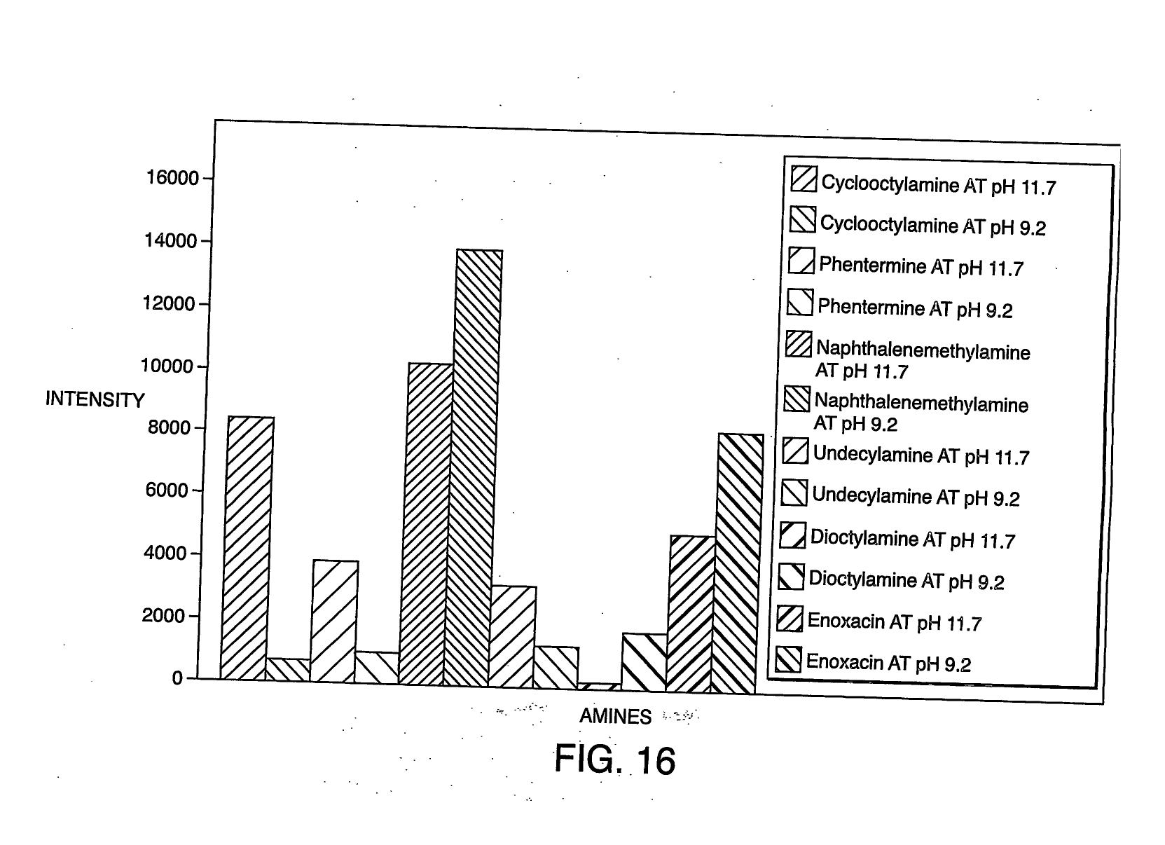

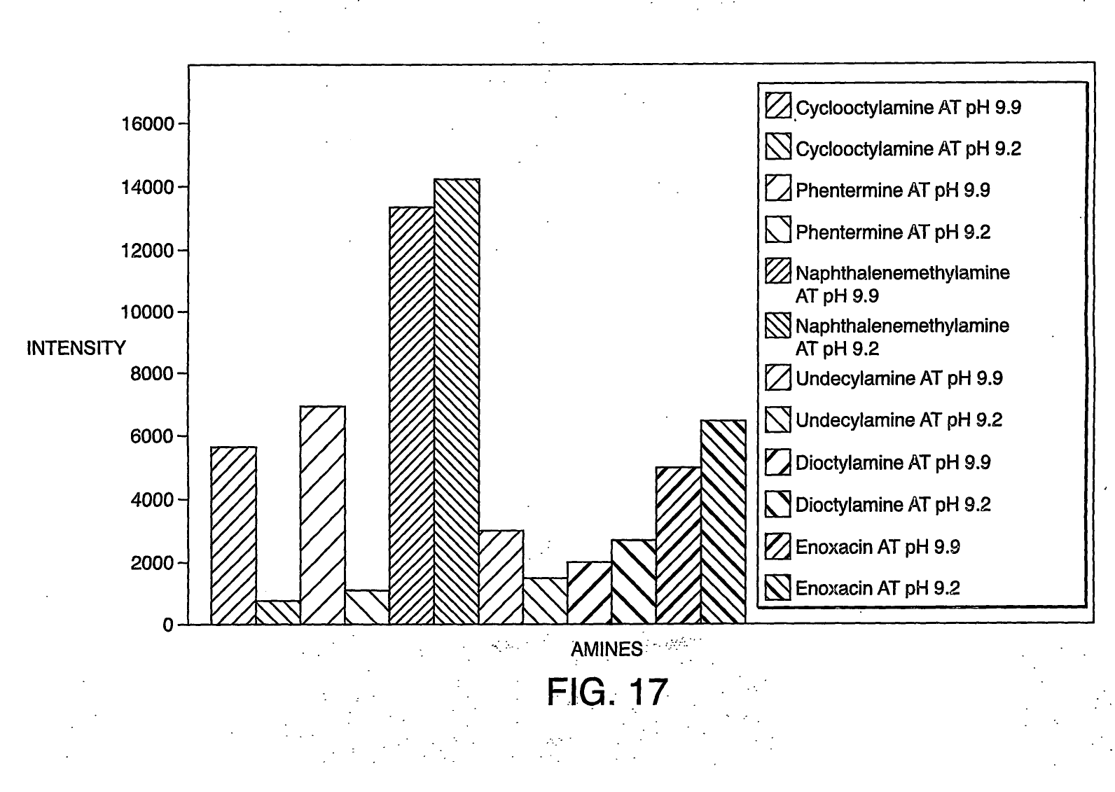

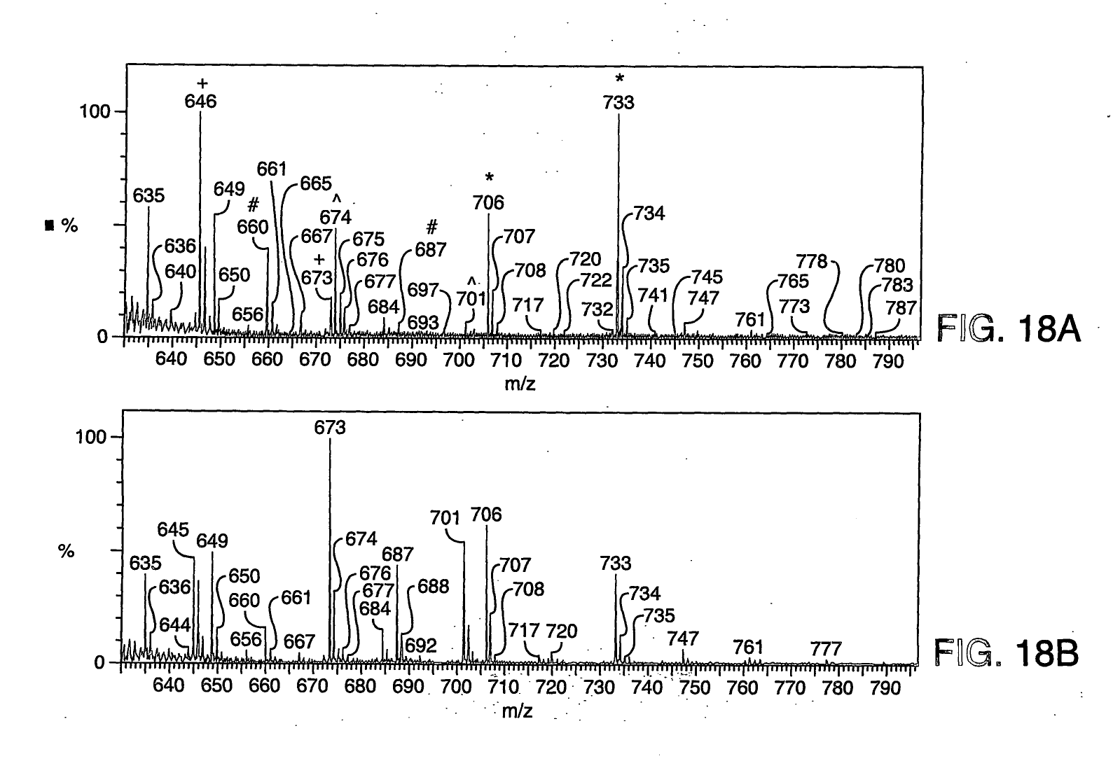

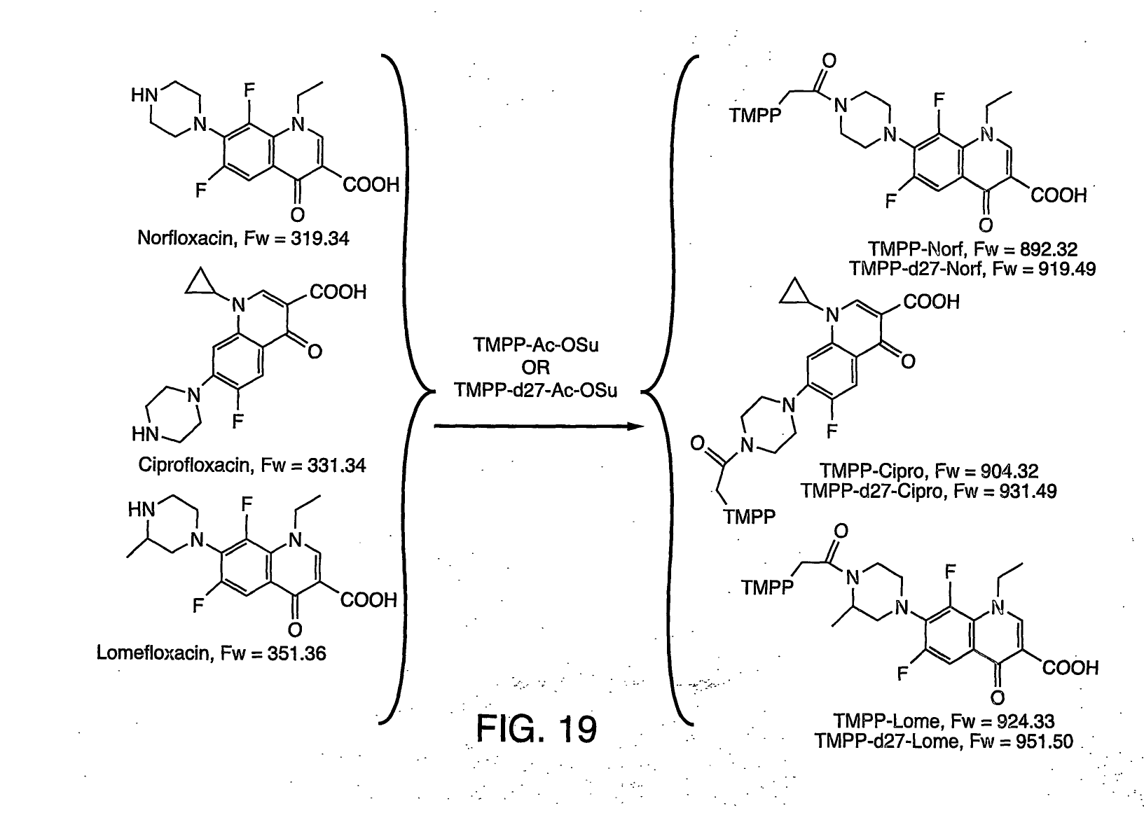

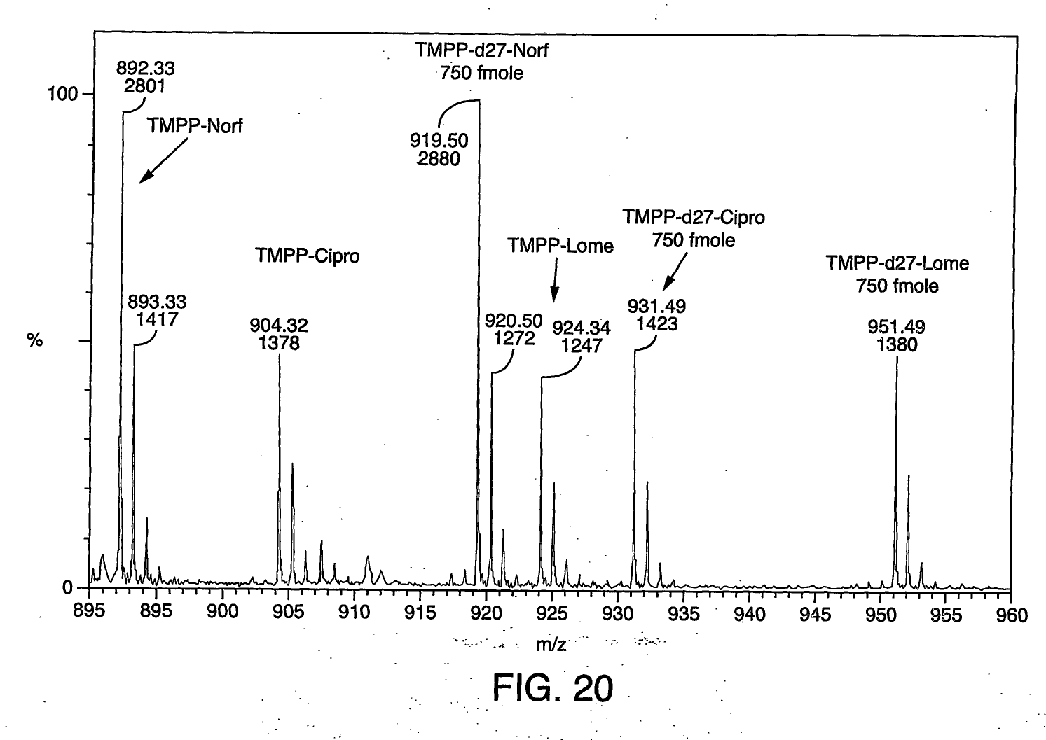

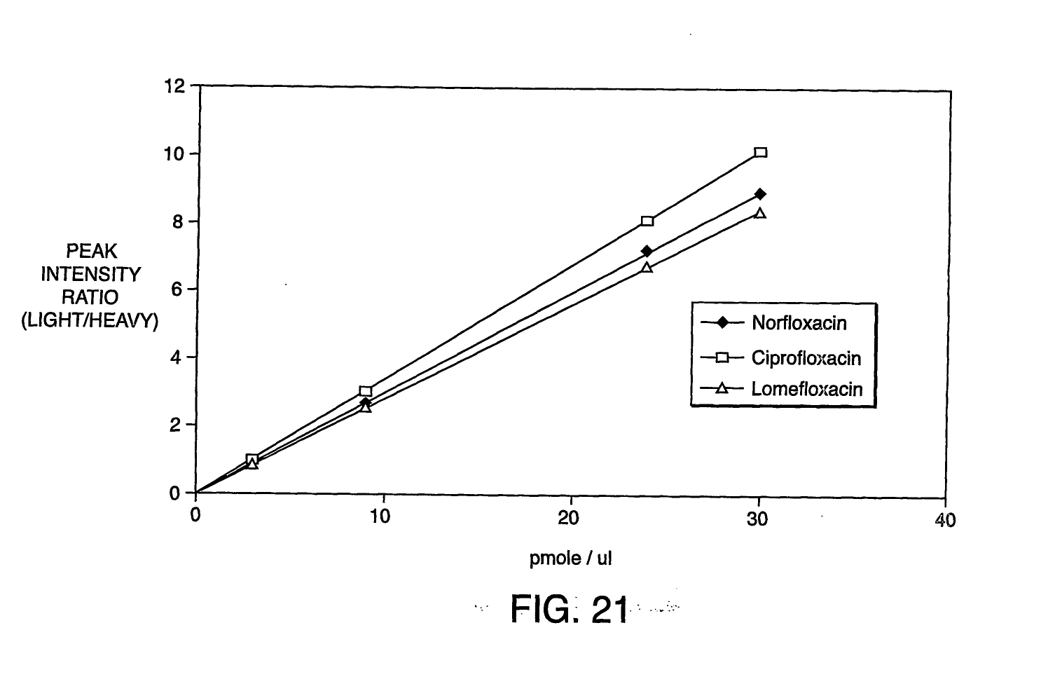

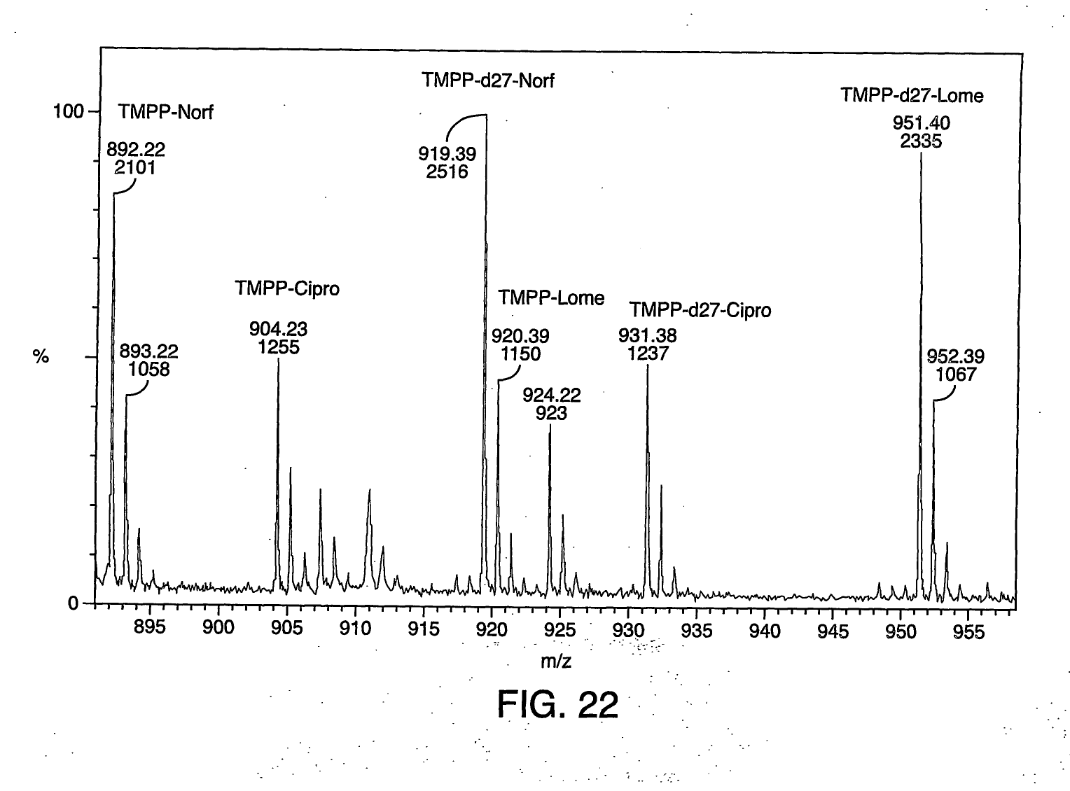

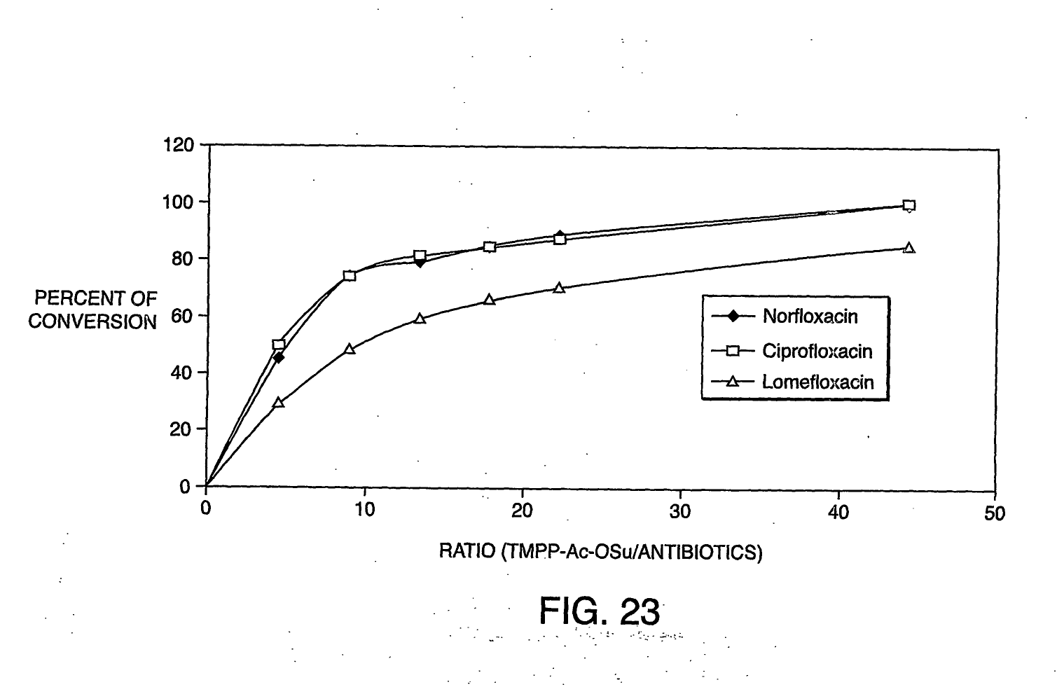

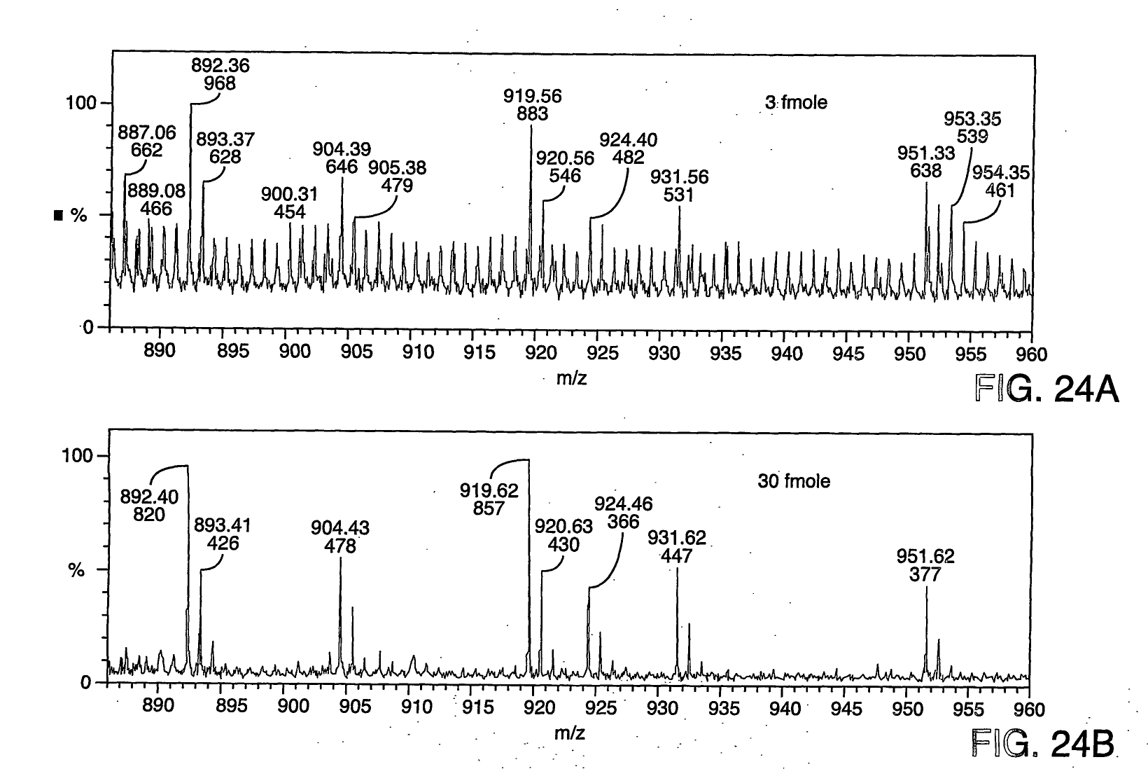

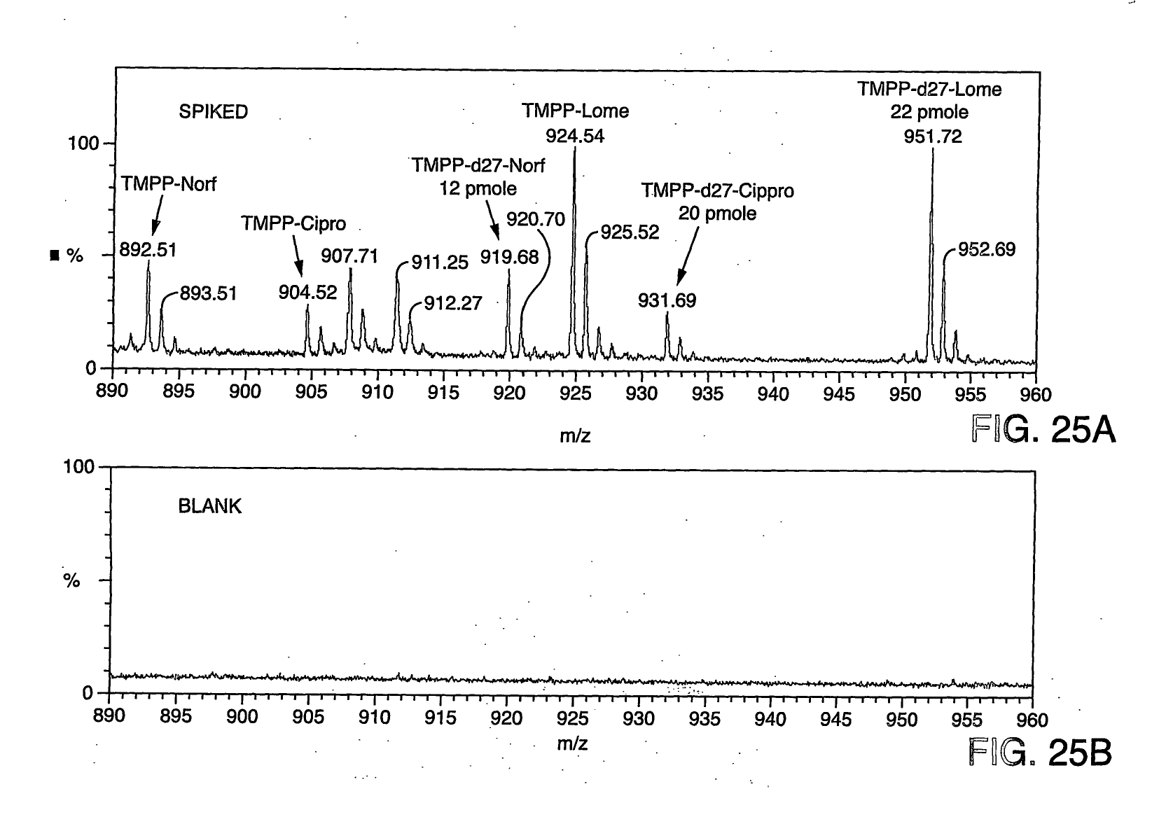

FIGS. 12A and 12B show a mass spectrum of 200 fmol of Cytochrome C tryptic digest, prepared by mixing 400 μL of 81 pmole/μL tryptic digested Cytochrome C (in 20 mM of triethylammonium bicarbonate) and 100 μL of 33.8 nmole/μL of TMPP—Ac—OSu (in CH₃CN), letting the mixture stand at room temperature for three hours, and then mixing 10 μL of the reaction mixture with 990 μL 0.1% TFA water solution, and spotting 2 μL thereof onto a MassPrep Target Plate and letting it dry. Sequence coverage comparison for peptides identified using non-derivatized (FIG. 12A) and derivatized (FIG. 12B) samples:
nonderivatized sample=GDVEKGKKI-FVQKCAQCHTVEKGGKHKTGPNLHGLFGRKTGQAPGFTYTDANKNKGITWK EETL-MEYLENPKKYIPGTKMIFAGIKKKTEREDLIAYLKKATNE (Sequence
Coverage: 54/104=52%) and derivatized sample=GDVEKGKKIFVQKCAQCHTVEKGGKHKT-GPNLHGLFGRKTGQAPGFTYTDANKNKGITWKEETLMEYLENPKKYIPGTKMI-FAGIKKKTEREDLIAYLKKATNE (Sequence Coverage: 81/104=79%).

FIG. 13 shows the structures of some amines discussed below.

FIG. 14 is a MALDI mass spectrum of derivatized amines (2 pmole) of FIG. 13.

FIGS. 15A and 15B are a comparison of 6 amines derivatized at different pH values.

FIGS. 16 and 17 are the results of pH studies of labeling reactions of various amines.

FIGS. 18A and 18B illustrate some characteristic peaks in MALDI mass spectra.

FIG. 19 shows a labeling reaction of some antibiotics.

FIG. 20 shows a typical mass spectrum used in the quantitative analysis of the antibiotics.

FIG. 21 is a calibration curve of antibiotics MS data.

FIGS. 22 and 23 show the results of a study of the conversion ratio of the labeling reaction in FIG. 19.

FIGS. 24A and 24B illustrate the very low detection limit of the MALDI method.

FIGS. 25A and 25B show the results of a study of antibiotics in a bovine kidney extraction simulation. Briefly, 1 gram of fresh bovine kidney and 10 mL of EtOH (with 2% CH₃COOH) was placed in a plastic tube, milled, and centrifuged to remove precipitates. The solution was transferred to a new tube and 30 ml of 50 mM triethylammonium bicarbonate solution was added. A blank kidney extraction control was prepared by mix 2 mL of kidney extraction and 10 mL of 50 mM triethylammonium bicarbonate solution. A spiked kidney extract was prepared by adding Norfloxacin 59 pmole/μL, Ciprofloxacin 97.5 pmole/μL, and Lomefloxacin 108.3 pmole/μL. The results demonstrated quantitative analysis of antibiotics by MALDI-MS with desirable calibration curves from low femtomole to picomole concentration ranges, including detection at 30 fentomole or lower

### DETAILED DESCRIPTION OF THE INVENTION

The present invention relates to methods of preparing samples for mass spectrometry analysis by labeling or tagging analytes in a sample with a triarylphosphonium labeling reagent.

1. Labeling Reagents

The labeling reagents of the invention may be represented by the formula [Ar₃P⁺R]X⁻, in which each Ar is an aryl group (all of which may the same or different), P is a phosphorous atom, R is a “reactive group;” and X⁻ is a negatively-charged counter ion. The reactive group has a reactive functional group that reacts with an exposed functional group of an analyte to form a covalent bond, thereby linking the analyte to the triarylphosphonium group of the labeling reagent. The reactive group R may be represented by -Z-Ψ, wherein Z is a linking group and Ψ is a reactive functional group, particularly a functional group that reacts with an exposed functional group of an analyte Accordingly, the labeling reagents of the invention may be represented by Formula I:

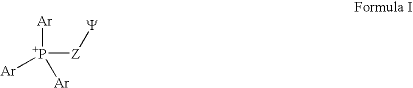

The nature of the reactive functional group (Ψ) will depend on the chemical characteristics of the analytes to be labeled. Generally, the labeling reagents of the invention react with an exposed functional group of an analyte. As used herein, an “exposed” functional group is one that is available to participate in a chemical reaction in which it becomes covalently bonded to a labeling reagent of the invention. In the simplest terms, when an analyte has an exposed functional group that is nucleophilic, then labeling reagents having an electrophilic Ψ group may be used, and vice versa.

In general, the term “nucleophile” is art-recognized to mean a chemical group having a reactive pair of electrons that reacts with a compound by displacing a leaving group (commonly another nucleophile), such as commonly occur in aliphatic chemistry as unimolecular (known as “S_{N}1”) or bimolecular (“S_{N}2”) reactions. Examples of nucleophiles include uncharged compounds such as amines, mercaptans, and alcohols, and charged groups such as alkoxides, thiolates, carbanions, and a variety of organic and inorganic anions. Illustrative anionic nucleophiles include, inter alia, simple anions such as azide, cyanide, thiocyanate, acetate, formate, or chloroformate, and bisulfite. Organometallic reagents such as organocuprates, organozincs, organolithiums, Grignard reagents, enolates, and acetylides, which under appropriate reaction conditions, be suitable nucleophiles.

Similarly, an “electrophile” means an atom, molecule, or ion able to accept an electron pair, particularly a pair of electrons from a nucleophile, such as typically occurs during an electrophilic substitution reaction. In an electrophilic substitution reaction, an electrophile binds to a substrate with the expulsion of another electrophile, e.g., the substitution of a proton by another electrophile such as a nitronium ion on an aromatic substrate (e.g., benzene). Electrophiles include cyclic compounds such as epoxides, aziridines, episulfides, cyclic sulfates, carbonates, lactones, and lactams; and non-cyclic electrophiles include sulfates, sulfonates (e.g., tosylates), chlorides, bromides, and iodides. Generally, an electrophile may be a saturated carbon atom (e.g., a methylene group) bonded to a leaving group; however, an electrophile may also be an unsaturated group, such as an aldehyde, ketone, ester, or conjugated (α, β-unsaturated) analog thereof, which upon reaction with a nucleophile forms an adduct.

The term “leaving group” generally refers to a group that is readily displaced and substituted by a nucleophile (e.g., an amine, a thiol, an alcohol, or cyanide). Such leaving groups are well known and include carboxylates, N-hydroxysuccinimide (“NHS”), N-hydroxybenzotriazole, a halogen (fluorine, chlorine, bromine, or iodine), alkoxides, and thioalkoxides. A variety of sulfur-based leaving groups are routinely used in synthetic chemistry, including alkane sulfonyloxy groups (e.g., C₁-C₄ alkane such as methane sulfonyloxy, ethane sulfonyloxy, propane sulfonyloxy, and butane sulfonyloxy groups) and the halogenated analogs (e.g., halogeno(C₁-C₄ alkane) sulfonyloxy groups, such as trifluoromethane sulfonyloxy (i.e., triflate), 2,2,2-trichloroethane sulfonyloxy, 3,3,3-tribromopropane sulfonyloxy, and 4,4,4-trifluorobutane sulfonyloxy groups), as well as arylsulfonyloxy groups (e.g., C₆-C₁₀ aryl optionally substituted with 1 to 3 C₁-C₄ alkyl groups, such as benzene sulfonyloxy, α-naphthylsulfonyloxy, β-naphthylsulfonyloxy, p-toluenesulfonyloxy (i.e., tosylates), 4-tert-butylbenzene sulfonyloxy, mesitylene sulfonyloxy, and 6-ethyl-α-naphthylsulfonyloxy groups).

“Activated esters” may be represented by the formula —COL, where L is a leaving group, typical examples of which include N-hydroxysulfosuccinimidyl and N-hydroxysuccinimidyl groups; aryloxy groups substituted with electron-withdrawing groups (e.g., p-nitro, pentafluoro, pentachloro, p-cyano, or p-trifluoromethyl); and carboxylic acids activated by a carbodiimide to form an anhydride or mixed anhydride, e.g., —OCOR^{a} or —OCNR^{a}NHR^{b}, where R^{a} and R^{b} are independently C₁-C₆ alkyl, C₅-C₈ allyl (e.g., cyclohexyl), C₁-C₆ perfluoroalkyl, or C₁-C₆ alkoxy groups. An activated ester may be formed in situ or may be an isolable reagent.

The term “electron-withdrawing group” is art-recognized and describes the ability of a substituent to attract valence electrons (e.g. pi-electrons) from neighboring atoms, e.g., the substituent is more electronegative than neighboring atoms, or it draws electrons to itself more than a hydrogen atom would at the same position. The Hammett sigma value (σ) is an accepted measure of a group's electron-donating and withdrawing ability, especially the sigma para value (σₚ). See, e.g., “Advanced Organic Chemistry” by J. March, 5^{th} Ed., John Wiley & Sons, Inc., New York, pp. 368-75 (2001). The Hammett constant values are generally negative for electron-donating groups (σₚ=−0.66 for NH₂) and positive for electron-withdrawing groups (σₚ=0.78 for a nitro group), σₚ indicating para substitution. Exemplary electron-withdrawing groups include nitro, acyl ketone), formyl (aldehyde), sulfonyl, trifluoromethyl, halogeno (e.g., chloro and fluoro), and cyano groups, among others. Conversely, an “electron-donating group” designates a substituent that contributes electrons more than hydrogen would if it occupied the same position in the molecule. Examples include amino is (including alkylamino and dialkylamino), aryl, alkoxy (including aralkoxy), aryloxy, mercapto and alkylthio, and hydroxyl groups, among others.

As used herein, alkyl groups include saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (isopropyl, tert-butyl, sec-butyl, isobutyl, etc.), and alkyl-substituted alkyl groups (e.g., alkyl-substituted cycloalkyl groups and cycloalkyl-substituted alkyl groups). The term “aliphatic group” includes organic moieties characterized by straight or branched-chains, typically having between 1 and 22 carbon atoms. In complex structures, the chains may be branched, bridged, or cross-linked. Aliphatic groups include alkyl groups, alkenyl groups, and alkynyl groups.

In certain embodiments, a straight-chain or branched-chain alkyl group may have 30 or fewer carbon atoms in its backbone, e.g., C₁-C₃₀ for straight-chain or C₃-C₃₀ for branched-chain. In certain embodiments, a straight-chain or branched-chain alkyl group may have 20 or fewer carbon atoms in its backbone, e.g., C₁-C₂₀ for straight-chain or C₃-C₂₀ for branched-chain, and more preferably 18 or fewer. Likewise, preferred cycloalkyl groups have from 4-10 carbon atoms in their ring structure, and more preferably have 4-7 carbon atoms in the ring structure. The term “lower alkyl” refers to alkyl groups having from 1 to 6 carbons in the chain, and to cycloalkyl groups having from 3 to 6 carbons in the ring structure.

Unless the number of carbons is otherwise specified, “lower” as in “lower aliphatic,” “lower alkyl,” “lower alkenyl,” etc. as used herein means that the moiety has at least one and less than about 8 carbon atoms. In certain embodiments, a straight-chain or branched-chain lower alkyl group has 6 or fewer carbon atoms in its backbone (e.g., C₁-C₆ for straight-chain, C₃-C₆ for branched-chain), and more preferably 4 or fewer. Likewise, preferred cycloalkyl groups have from 3-8 carbon atoms in their ring structure, and more preferably have 5 or 6 carbons in the ring structure. The term “C₁-C₆” as in “C₁-C₆ alkyl” means alkyl groups containing 1 to 6 carbon atoms.

Moreover, unless otherwise specified the term alkyl includes both “unsubstituted alkyls” and “substituted alkyls,” the latter of which refers-to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or aromatic (including heteroaromatic) groups.

An “arylalkyl” group is an alkyl group substituted with an aryl group (e.g., phenylmethyl (ie., benzyl)). An “alkylaryl” moiety is an aryl group substituted with an alkyl group (e.g.,p-methylphenyl (i.e.,p-tolyl)). The term “n-alkyl” means a straight-chain (i.e., unbranched) unsubstituted alkyl group. An “alkylene” group is a divalent analog of the corresponding alkyl group. The terms “alkenyl” and “alkynyl” refer to unsaturated aliphatic groups analogous to alkyls, but which contain at least one double or triple carbon-carbon bond respectively. Suitable alkenyl and alkynyl groups include groups having 2 to about 12 carbon atoms, preferably from 2 to about 6 carbon atoms.

The term “aromatic group” or “aryl group” includes unsaturated and aromatic cyclic hydrocarbons as well as unsaturated and aromatic heterocycles containing one or more rings. Aryl groups may also be fused or bridged with alicyclic or heterocyclic rings that are not aromatic so as to form a polycycle (e.g. tetralin). An “arylene” group is a divalent analog of an aryl group.

The term “heterocyclic group” includes closed ring structures analogous to carbocyclic groups in which one or more of the carbon atoms in the ring is an element other than carbon, for example, nitrogen, sulfur, or oxygen. Heterocyclic groups may be saturated or unsaturated. Additionally, heterocyclic groups (such as pyrrolyl, pyridyl, isoquinolyl, quinolyl, purinyl, and furyl) may have aromatic character, in which case they may be referred to as “heteroaryl” or “heteroaromatic” groups.

Unless otherwise stipulated, aryl and heterocyclic (including heteroaryl) groups may also be substituted at one or more constituent atoms. Examples of heteroaromatic and heteroalicyclic groups may have 1 to 3 separate or fused rings with 3 to about 8 lo members per ring and one or more N, O, or S heteroatoms. In general, the term “heteroatom” includes atoms of any element other than carbon or hydrogen, preferred examples of which include nitrogen, oxygen, sulfur, and phosphorus. Heterocyclic groups may be saturated or unsaturated or aromatic.

A common hydrocarbon aryl group is a phenyl group having one ring. Two-ring hydrocarbon aryl groups include naphthyl, indenyl, benzocyclooctenyl, benzocycloheptenyl, pentalenyl, and azulenyl groups, as well as the partially hydrogenated analogs thereof such as indanyl and tetrahydronaphthyl. Exemplary three-ring hydrocarbon aryl groups include acephthylenyl, fluorenyl, phenalenyl, phenanthrenyl, and anthracenyl groups.

Aryl groups also include heteromonocyclic aryl groups, i.e., single-ring heteroaryl groups, such as thienyl, furyl, pyranyl, pyrrolyl, imidazolyl, pyrazolyl, pyridinyl, pyrazinyl, pyrimidinyl, and pyridazinyl groups; and oxidized analogs thereof such as pyridonyl, oxazolonyl, pyrazolonyl, isoxazolonyl, and thiazolonyl groups. The corresponding hydrogenated (i.e., non-aromatic) heteromonocylic groups include pyrrolidinyl, pyrrolinyl, imidazolidinyl, imidazolinyl, pyrazolidinyl, pyrazolinyl, piperidyl and piperidino, piperazinyl, and morpholino and morpholinyl groups.

Aryl groups also include fused two-ring heteroaryls such as indolyl, isoindolyl, indolizinyl, indazolyl, quinolinyl, isoquinolinyl, phthalazinyl, quinoxalinyl, quinazolinyl, cinnolinyl, chromenyl, isochromenyl, benzothienyl, benzimidazolyl, benzothiazolyl, purinyl, quinolizinyl, isoquinolonyl, quinolonyl, naphthyridinyl, and pteridinyl groups, as well as the partially hydrogenated analogs such as chromanyl, isochromanyl, indolinyl, isoindolinyl, and tetrahydroindolyl groups. Aryl groups also include fused three-ring groups such as phenoxathiinyl, carbazolyl, phenanthridinyl, acridinyl, perimidinyl, phenanthrolinyl, phenazinyl, phenothiazinyl, phenoxazinyl, and dibenzofuranyl groups.

The term “amino,” as used herein, refers to an unsubstituted or substituted moiety of the formula —NR^{a}R^{b}, in which R^{a} and R^{b} are each independently hydrogen, alkyl, aryl, or heterocyclyl, or R^{a} and R^{b}, taken together with the nitrogen atom to which they are attached, form a cyclic moiety having from 3 to 8 atoms in the ring. Thus, the term “amino” includes cyclic amino moieties such as piperidinyl or pyrrolidinyl groups, unless otherwise stated. Thus, the term “alkylamino” as used herein means an alkyl group having an amino group attached thereto. Suitable alkylamino groups include groups having 1 to about 12 carbon atoms, preferably from 1 to about 6 carbon atoms.

The term “alkylthio” refers to an alkyl group, having a sulfhydryl group attached thereto. Suitable alkylthio groups include groups having 1 to about 12 carbon atoms, preferably from 1 to about 6 carbon atoms.

The term “alkylcarboxyl” as used herein means an alkyl group having a carboxyl group attached thereto.

The term “alkoxy” as used herein means an alkyl group having an oxygen atom attached thereto. Representative alkoxy groups include groups having 1 to about 12 carbon atoms, preferably 1 to about 6 carbon atoms, e.g., methoxy, ethoxy, propoxy, tert-butoxy and the like.

The term “nitro” means —NO₂; the term “halogen” or “halogeno” or “halo” designates —F, —Cl, —Br or —I; the term “thiol,” “thio,” or “mercapto” means SH; and the term “hydroxyl” or “hydroxy” means —OH.

Unless otherwise specified, the chemical moieties of the compounds of the invention, including those groups discussed above, may be “substituted or unsubstituted.” In some embodiments, the term “substituted” means that the moiety has substituents placed on the moiety other than hydrogen (i.e., in most cases, replacing a hydrogen), which allow the molecule to perform its intended function. Examples of substituents include moieties selected from straight or branched alkyl (preferably C₁-C₅), cycloalkyl (preferably C₃-C₈), alkoxy (preferably C₁-C₆), thioalkyl (preferably C₁-C₆), alkenyl (preferably C₂-C₆), alkynyl (preferably C₂-C₆), heterocyclic, carbocyclic, aryl (e.g., phenyl), aryloxy (e.g., phenoxy), aralkyl (e.g., benzyl), aryloxyalkyl (e.g., phenyloxyalkyl), arylacetamidoyl, alkylaryl, heteroaralkyl, alkylcarbonyl and arylcarbonyl or other such acyl group, heteroarylcarbonyl, and heteroaryl groups, as well as (CR′R″)₀₋₃NR′R″ (e.g., —NH₂), (CR′R″)₀₋₃CN (e.g., —CN), —NO₂, halogen (e.g., —F, —Cl, —Br, or —I), (CR′R″)₀₋₃C(halogen)₃ (e.g., —CF₃), (CR′R″)₀₋₃CH(halogen)₂, (CR′R″)₀₋₃CH₂(halogen), (CR′R″)₀₋₃CONR′R″, (CR′R″)₀₋₃(CNH)NR′R″, (CR′R″)₀₋₃S(O)₁₋₂NR′R″, (CR′R″)₀₋₃CHO, (CR′R″)₀₋₃O(CR′R″)₀₋₃H, (CR′R″)₀₋₃S(O)₀₋₃R′ (e.g., —SO₃H), (CR′R″)₀₋₃O(CR′R″)₀₋₃H (e.g., —CH₂OCH₃ and —OCH3), (CR′R″)₀₋₃S(CR′R″)₀₋₃H (e.g., —SH and —SCH₃), (CR′R″)₀₋₃OH (e.g., —OH), (CR′R″)₀₋₃COR′, (CR′R″)₀₋₃(substituted or unsubstituted phenyl), (CR′R″)₀₋₃(C₃-C₈ cycloalkyl), (CR′R″)₀₋₃CO₂R′ (e.g., —CO₂H), and (CR′R″)₀₋₃OR′ groups, wherein R′ and R″ are each independently hydrogen, a C₁-C₅ alkyl, C₂-C₅ alkenyl, C₂-C₅ alkynyl; or aryl group; or the, side chain of any naturally occurring amino acid.

In some embodiments, a “substituent” may be, selected from the group consisting of, for example, halogeno, trifluoromethyl, nitro, cyano, C₁-C₆ alkyl, C₂-C₆ alkenyl, C₂-C₆ alkynyl, C₁-C₆ alkylcarbonyloxy, arylcarbonyloxy, C₁-C₆ alkoxycarbonyloxy, aryloxycarbonyloxy, C₁-C₆ alkylcarbonyl, C₁-C₆ alkoxycarbonyl, C₁-C₆ alkoxy, C₁-C₆ alkylthio, arylthio, heterocyclyl, aralkyl, and aryl (including heteroaryl) groups.

In one embodiment, the labeling reagent of the invention has an activated ester reactive functional group (Ψ), and may therefore be represented by Formula II, wherein L is a leaving group. Such labeling reagents are useful in labeling analytes having nucleophilic exposed functional groups, such as an amine. In a similar embodiment of the invention, the activated ester is connected to the triarylphosphonium group by a methylene group (i.e., Z=CH₂), as in Formula IIa:

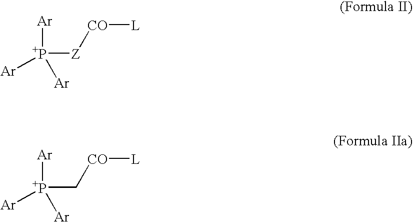

Sulfosuccinimidyl esters, pentafluorothiophenol esters, and sulfotetrafluorophenol are preferred embodiments of Formula II. However, the ester leaving group of Formula II may be, for example, substituted or unsubstituted C₁-C₆ alkyl (such as methyl, ethyl, propyl, isopropyl, butyl, isobutyl, sec-butyl, tert-butyl, pentyl, or hexyl), or substituted or unsubstituted C₆-C₁₄ aryl or heterocyclic groups, such as 2-fluoroethyl, 2-chloroethyl, 2-bromoethyl, 2,2-dibromoethyl, 2,2,2-trichloroethyl, 3-fluoropropyl, 4-chlorobutyl, methoxymethyl, 1,1-dimethyl-1-methoxymethyl, ethoxymethyl, N-propoxymethyl, isopropoxymethyl, N-butoxymethyl, tert-butoxymethyl, 1-ethoxyethyl, 1-methyl-1-methoxyethyl, 1-(isopropoxy)ethyl, 3-methoxypropyl-4-methoxybutyl, fluoromethoxymethyl, 2,2,2-trichloroethoxymethyl, bis(2-chloroethoxy)methyl, 3-fluoropropoxymethyl, 4-chlorobutoxyethyl, dibromomethoxyethyl, 2-chloroethoxypropyl, fluoromethoxybutyl, 2-methoxyethoxymethyl, ethoxymethoxyethyl, methoxyethoxypropyl, methoxyethoxybutyl, benzyl, phenethyl, 3-phenylpropyl, 4-phenylbutyl, α-naphthylmethyl, β-naphthylmethyl, diphenylmethyl, triphenylmethyl, α-naphthyldipheylmethyl, 9-anthrylmethyl, 4-methylbenzyl, 2,4,6-trimethylbenzyl, 3,4,5-trimethylbenzyl, 4-methoxybenzyl, 4-methoxyphenyldiphenylmethyl, 2-nitrobenzyl, 4-nitrobenzyl, 4-chlorobenzyl, 4-bromobenzyl, 4-cyanobenzyl, 4-cyanobenzyldiphenylmethyl, or bis(2-nitrophenyl)methyl groups.

In one aspect, the invention is a method of preparing a sample for mass spectrometry analysis, comprising first obtaining a sample comprising an analyte, wherein the analyte comprises an exposed group; and reacting the analyte with a labeling reagent according to the Formula [Ar₃P⁺R]X⁻, wherein each Ar is an aryl group, all of which may the same or different; P is a phosphorous atom; R is a reactive group comprising a functional group that reacts with the exposed functional group to form a covalent bond, thereby linking the analyte to the triarylphosphonium group of the labeling reagent; and X⁻ is a negatively-charged counter ion.

In another embodiment, the invention is a method of preparing a sample for mass spectrometry analysis, comprising obtaining a triarylphosphonium labeling reagent having a reactive group; obtaining a sample containing an analyte that has an exposed group and that is capable of reacting with the reactive group to thereby form a triarylphosphonium-linked analyte; and reacting the labeling reagent with the analyte such that the triarylphosphonium-linked analyte is formed. According to such a method, the labeling reagent may have the structure [Ar₃P⁺R]X⁻, wherein each Ar is an aryl group, all of which may the same or different; P is a phosphorous atom; R is a reactive group comprising a functional group that reacts with the exposed functional group to form a covalent bond thereby forming triarylphosphonium-linked analytes; and X⁻ is a negatively-charged counter ion.

In another aspect, the invention is a method of preparing a sample for mass spectrometry analysis, comprising first obtaining a sample comprising an analyte, wherein the analyte comprises an exposed group; and reacting the analyte with at least two labeling reagents (or a plurality of reagents), each according to the formulae [Ar₃P⁺R]X⁻, where Ar is an aryl group, all of which may the same or different, such that the molecular weight of the Ar₃P groups of each labeling reagent is unique with respect to the molecular weights of the other Ar₃P groups of the other labeling reagents.

Also, the invention is a method of preparing a sample for mass spectrometry analysis, comprising obtaining at least two triarylphosphonium labeling reagents each having a reactive group, wherein the reactive groups of the labeling reagents are all the same, and the molecular weights of the triarylphosphonium groups of the labeling reagents are different from each other; obtaining a sample containing an analyte that has an exposed group and that is capable of reacting with the reactive group to thereby form a triarylphosphonium-linked analyte; and reacting the labeling reagents with the analyte such that the triarylphosphonium-linked analytes are formed.

In the methods of the invention, it is preferred that the aforementioned differences in the molecular weights of the triarylphosphonium groups is discernable by mass spectrometry. Similarly, it is preferred that the differences in the molecular weights of the triarylphosphonium-linked analytes is also discernable by mass spectrometry. Molecular weights are discernable by mass spectrometry if their MS signals do not significantly overlap, or the peak areas of each molecular ion are not subject to interference with each other.

In another representation, the invention is a method of preparing a sample for mass spectrometry analysis, comprising obtaining a sample comprising an analyte, wherein the analyte comprises an exposed group; and reacting the analyte with at least two labeling reagents according to the formulae [Ar₃P⁺R]X⁻, [Ar* ₃P⁺R]X⁻, [Ar**₃P⁺R]X⁻, and so on, wherein the Ar groups (i.e., Ar, Ar*, and Ar**, etc.) are aryl groups, all of which may the same or different, such that the molecular weights of the triarylphosphonium groups of each labeling reagent are unique; P is a phosphorous atom; R is a reactive group comprising a functional group that reacts with the exposed functional group to form a covalent bond thereby forming triarylphosphonium-linked analytes; and X⁻ is a negatively-charged counter ion.

The invention is also a method of analyzing a sample, comprising obtaining a sample comprising an analyte, wherein the analyte comprises an exposed group; forming a triarylphosphonium-linked analyte by reacting the analyte with a labeling reagent according to the Formula [Ar₃P⁺R]X⁻, wherein each Ar is an aryl group, all of which may the same or different; P is a phosphorous atom; R is a reactive group comprising a functional group that reacts with the exposed functional group to form a covalent bond thereby forming a triarylphosphonium-linked analyte; and X⁻ is a negatively-charged counter ion; such that the triarylphosphonium-linked analyte is formed; and analyzing the triarylphosphonium-linked analyte by mass spectrometry.

In yet another embodiment, the invention is a method of analyzing a sample, comprising obtaining a triarylphosphonium labeling reagent having a reactive group; obtaining a sample containing an analyte that has an exposed group and that is capable of reacting with the reactive group to thereby form a triarylphosphonium-linked analyte; reacting the labeling reagent with the analyte such that the triarylphosphonium-linked analyte is formed; and analyzing the triarylphosphonium-linked analyte by mass spectrometry. In such a method, the labeling reagents of the invention may have a structure according to the formula [Ar₃P⁺R]X⁻, wherein each Ar is an aryl group, all of which may the same or different; P is a phosphorous atom; R is a reactive group comprising a functional group that reacts with the exposed functional group to form a covalent bond thereby forming triarylphosphonium-linked analytes; and X⁻ is a negatively-charged counter ion.

Accordingly, the invention includes a method of analyzing a sample, comprising obtaining a sample comprising an analyte, wherein the analyte comprises an exposed group; and reacting the analyte with at least two labeling reagents according to the formulae [Ar₃P⁺R]X⁻ and [Ar*₃P⁺R]X⁻, wherein Ar and Ar* are aryl groups, all of which may the same or different, such that the molecular weight of Ar₃P is different from the molecular weight of Ar*₃P; P is a phosphorous atom; R is a reactive group comprising a functional group that reacts with the exposed functional group to form a covalent bond thereby forming a triarylphosphonium-linked analyte; and X⁻ is a negatively-charged counter ion; and analyzing the triarylphosphonium-linked analyte by a mass spectrometry technique.

In still another aspect, the invention is a method of analyzing a sample, comprising obtaining at least two triarylphosphonium labeling reagents each having a reactive group, wherein the reactive groups of the labeling reagents are all the same, and the molecular weights of the triarylphosphonium groups of the labeling reagents are different from each other; obtaining a sample containing an analyte that has an exposed group and that is capable of reacting with the reactive group to thereby form a triarylphosphonium-linked analyte; reacting the labeling reagents with the analyte such that the triarylphosphonium-linked analytes are formed; and analyzing the triarylphosphonium-linked analyte by a mass spectrometry technique. According to such methods, the each of the labeling reagent may have a structure according to the formula (Ar₃P⁻R]X⁻, wherein each Ar is an aryl group, all of which may the same or different, such that the molecular weights of the triarylphosphonium groups of each labeling reagent are unique; P is a phosphorous atom; R is a reactive group comprising a functional group that reacts with the exposed functional group to form a covalent bond thereby forming triarylphosphonium-linked analytes; and X⁻ is a negatively-charged counter ion.

According to the methods of the invention, the analyzing step is typically a mass spectrometry technique. The mass spectrometry technique preferably is matrix-assisted laser desorption/ionization mass spectrometry or electrospray mass spectrometry. Furthermore, the mass spectrometry technique is preferably quantitative.

An example of a quantitative method of the invention includes the steps of first obtaining at least two triarylphosphonium labeling reagents each having a reactive group, wherein the reactive groups of the labeling reagents are all the same, and the molecular weights of the triarylphosphonium groups of the labeling reagents are different from each other; the obtaining a sample containing an analyte that has an exposed group and that is capable of reacting with the reactive group to thereby form a triarylphosphonium-linked analyte; reacting, in a first vessel, the first labeling reagent with a first portion of the sample such that triarylphosphonium-linked analytes thereof are formed; and then reacting, in a second vessel, the second labeling reagent with a second portion of the sample such that triarylphosphonium-linked analytes thereof are formed. After the reaction is complete, the triarylphosphonium-linked analytes from the first vessel are combined with triarylphosphonium-linked analytes from the second vessel to form a mixture; and then the mixture of triarylphosphonium-linked analytes is analyzed by a mass spectrometry technique.

Such quantitative methods may optionally further comprising quantitatively comparing the relative signals of the triarylphosphonium-linked analytes from the first vessel to the triarylphosphonium-linked analytes of the second vessel. In some cases, the quantitative comparison is correlated with the relative amounts of the triarylphosphonium-linked analytes. For example, the ratio of the first portion of the sample to the second portion of the sample may be predetermined and definite, thereby allowing quantitation. This may be correlated to the MS signals of the triarylphosphonium-linked analytes. Also, the difference in the signals of an analyte labeled with the first labeling reagent and the same analyte labeled with the second labeling reagent may be linearly related to the difference in their concentration in the mixture.

In the labeling reagents of the invention, each Ar group is selected from the group consisting of substituted or unsubstituted aryl groups. In some embodiments, each Ar group is selected from the group consisting of substituted or unsubstituted heteroaryl groups. In other embodiments, each Ar group is selected from the group consisting of substituted or unsubstituted aromatic hydrocarbons.

In still further embodiments, each Ar group is selected from the group consisting of substituted or unsubstituted phenyl, 1-naphthyl, 2-naphthyl, biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl groups.

Additionally, each Ar group may be selected from the group consisting of substituted or unsubstituted 5- and 6-membered single-ring groups. In another aspect, each Ar group may be selected from the group consisting of substituted or unsubstituted phenyl, pyrrolyl, furyl, thienyl, thiazolyl, isothiazolyl, imidazolyl, triazolyl, tetrazolyl, pyrazolyl, oxazolyl, isooxazolyl, pyridinyl, pyrazinyl, pyridazinyl, and pyrimidinyl groups.

Each Ar group may also be selected from the group consisting of substituted or unsubstituted multicyclic aryl groups. Each Ar group may also be selected from the group consisting of substituted or unsubstituted naphthyl, tetrahydronaphthyl, benzoxazolyl, benzodioxazolyl, benzothiazolyl, benzoimidazolyl, benzothiophenyl, methylenedioxyphenyl, quinolinyl, isoquinolinyl, napthyridinyl, indolyl, benzofuranyl, purinyl, deazapurinyl, and indolizinyl groups. In one aspect, two Ar groups together form one divalent aromatic group, such as divalent aromatic groups selected from the group consisting of substituted or unsubstituted 1,1′-binaphth-2,2′-diyl, phenylene, and xylylene groups. Furthermore, each Ar group may be selected from the group consisting of unsubstituted phenyl, unsubstituted naphthyl, unsubstituted indenyl, unsubstituted anthracenyl, substituted phenyl, substituted naphthyl, substituted indenyl, and substituted anthracenyl groups.

In one embodiment, the Ar₃P group is selected from the group consisting of substituted or unsubstituted triphenylphosphine, naphthyldiphenylphosphine, dinaphthylphenylphosphine, trinaphthylphosphine, 9-anthryldiphenylphosphine, 9-anthryldinaphthylphosphine, diphenylpyrenylphosphine, dinaphthylpyrenylphosphine. In a more particular embodiment, the naphthyl is 1-naphthyl or 2-naphthyl.

The aryl groups may be substituted. The substituents, for example, may be alkyl or alkoxy groups. The substituents may also be selected from the group consisting of halogens; C₁-C₆ alkyl groups; (C₁-C₄ alkoxy)-substituted C₁-C₆ alkyl groups; C₁-C₆ alkoxy groups; C₁-C₆ alkylthio groups; C₁-C₆ alkanoyl groups; C₁-C₆ alkanoyloxy groups; and C₁-C₆ alkoxycarbonyl groups. In some cases, the substituents are C₁-C₄ alkyl groups or C₁-C₄ alkylalkoxy groups.

The aryl substituents may also be selected from the group consisting of halogens; C₁-C₆ alkyl groups; (C₁-C₄ alkoxy)-substituted C₁-C₆ alkyl groups; C₁-C₆ alkoxy groups; C₁-C₆ alkylthio groups; C₁-C₆ alkanoyl groups; C₁-C₆ alkanoyloxy groups; and C₁-C₆ alkoxycarbonyl groups.

The Ar₃P group may be a substituted triphenylphosphine, such as tri(p-methoxyphenyl)-phosphine.

In another representation, the labeling reagent of the invention has a structure according to the formula 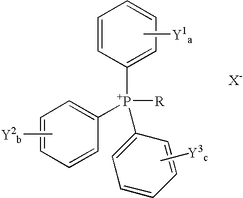
where P is a phosphorous atom; R is a reactive group comprising a functional group that reacts with the exposed functional group to form a covalent bond thereby forming triarylphosphonium-linked analytes; a, b, and c are independently integers from 0 to 5; Y¹, Y², and Y³, which may be the same or different, are independently selected from the group consisting of halogen, hydroxyl, alkylcarbonyloxy, arylcarbonyloxy, alkoxycarbonyloxy, aryloxycarbonyloxy, carboxylate, alkylcarbonyl, alkoxycarbonyl, aminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfate, sulfonato, sulfamoyl, sulfonamido, nitro, trifluoromethyl, cyano, azido, heterocyclyl, aralkyl, aryl, and heteroyl groups, provided that none of the Y groups reacts with the R group; and X⁻ is a negatively-charged counter ion. More particularly, the labeling reagent may have a structure according to the formula 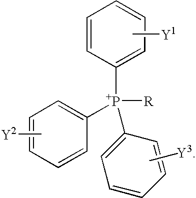
In either case, Y¹, Y², and Y³ may be selected from the group consisting of methyl, ethyl, propyl, isopropyl, butyl, isobutyl, pentyl, hexyl, heptyl, methyloxy, ethyloxy, propyloxy, isopropyloxy, butyloxy, isobutyloxy, pentyloxy, hexyloxy, and heptyloxy.

Likewise, the labeling reagent may have a structure according to the formula 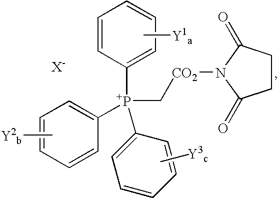
or the labeling reagent may have a structure according to the formula 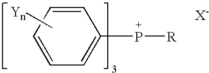
wherein P is a phosphorous atom; R is a reactive group comprising a functional group that reacts with the exposed functional group to form a covalent bond thereby forming triarylphosphonium-linked analytes; a, b, c, and n are each an integer from 0 to 5; Y, Y¹, Y², and Y³ are each selected from the group consisting of halogen, hydroxyl, alkylcarbonyloxy, arylcarbonyloxy, alkoxycarbonyloxy, aryloxycarbonyloxy, carboxylate, alkylcarbonyl, alkoxycarbonyl, aminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfate, sulfonato, sulfamoyl, sulfonamido, nitro, trifluoromethyl, cyano, azido, heterocyclyl, aralkyl, aryl, and heteroyl groups, provided that none of the Y groups reacts with the R group; and X⁻ is a negatively-charged counter ion.

In some cases, the Y, Y¹, Y², and Y³ groups are selected from the group consisting of methyl, ethyl, propyl, isopropyl, butyl, isobutyl, pentyl, hexyl, heptyl, methyloxy, ethyloxy, propyloxy, isopropyloxy, butyloxy, isobutyloxy, pentyloxy, hexyloxy, and heptyloxy.

The labeling reagents of the invention may also have a structure according to the formula 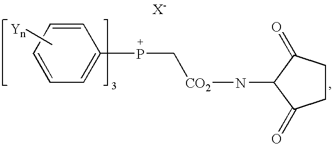
where Y, n, and X are as defined in any of the above embodiments.

In the labeling reagents of the invention according to one embodiment, each of the triarylphosphonium labeling reagent has the same chemical structure, and wherein each triarylphosphonium labeling reagent is isotopically enriched with respect to the other triarylphosphonium labeling reagents. The triarylphosphonium labeling reagent may be isotopically enriched with ¹²C, ¹²C, ¹H, or ²H. For example, in the structures depicted herein, Y¹, Y², and Y³ may be selected from the group consisting of O¹²C¹H₃, O¹²C²H₃, O¹³C¹H₃, and O¹³C²H₃.

The counter ion X⁻ may be a halide, triflate, sulfate, nitrate, hydroxide, carbonate, bicarbonate, acetate, phosphate, oxalate, cyanide, aklylcarboxylate, N-hydroxysuccinimide, N-hydroxybenzotriazole, alkoxide, thioalkoxide, alkane sulfonyloxy, halogenated alkane sulfonyloxy, arylsulfonyloxy, bisulfate, oxalate, valerate, oleate, palmitate, stearate, laurate, borate, benzoate, lactate, citrate, maleate, fumarate, succinate, tartrate, naphthylate mesylate, glucoheptonate, or lactobionate. In some cases, the counter ion X⁻ is an anionic Y group such that the labeling reagent is zwitterionic.

The invention may also be a composition comprising a labeling reagent as described herein. Furthermore, the invention pertains to any novel chemical compound described herein.

For example, the invention may be a composition comprising at least two different labeling reagents each having a different molecular weight according to the formula [Ar₃P⁺R]X⁻, wherein each Ar is aryl group, all of which may the same or different; P is a phosphorous atom; R is a reactive group comprising a functional group that reacts with the exposed functional group to form a covalent bond thereby forming a triarylphosphonium-linked analyte; and X⁻ is a negatively-charged counter ion.

Similarly, the invention includes a composition comprising at least two different labeling reagents each having a different molecular weight according to the formula 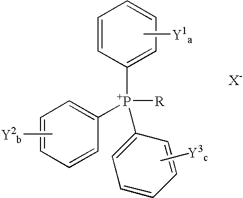
wherein P is a phosphorous atom; R is a reactive group comprising a functional group that reacts with the exposed functional group to form a covalent bond thereby forming triarylphosphonium-linked analytes; a, b, and c are independently integers from 0 to 5; Y¹, Y², and Y³, which may be the same or different, are independently selected from the group consisting of halogen, hydroxyl, alkylcarbonyloxy, arylcarbonyloxy, alkoxycarbonyloxy, aryloxycarbonyloxy, carboxylate, alkylcarbonyl, alkoxycarbonyl, aminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfate, sulfonato, sulfamoyl, sulfonamido, nitro, trifluoromethyl, cyano, azido, heterocyclyl, aralkyl, aryl, and heteroyl groups, provided that none of the Y groups reacts with the R group; and X⁻ is a negatively-charged counter ion.

The labeling reagents of the invention may be electrophilic or nucleophilic with respect to the analytes to be labeled. The electronic properties of the labeling reagents may be controlled at least partially by the selection of the aryl groups themselves, as well as the substituents bonded thereto. The solubility and reactivity of the labeling reagents are further design considerations when selecting aryl groups or their substituents.

2. Reactive Functional Groups (Ψ) and Linking Groups (Z)

The labeling reagents of the invention label a wide variety of substances, provided that the substance to be labeled contains a functional group that possesses suitable reactivity with at least one reactive functional group (Ψ). In the labeling reagents of the invention, the R group contains at least one reactive functional group (Ψ) that is bonded to the phosphorous atom of the triarylphosphonium via a lining group (Z).

The reactive functional group is chosen to complement the reactivity of an exposed functional group of an analyte. Typically, the reactive group Ψ is the simplest version of the reactive group that still retains appropriate reactivity. The types of functional groups typically present on the organic or inorganic analyte substance to be conjugated include, but are not limited to, amines, thiols, alcohols, phenols, aldehydes, ketones, imidazoles, hydrazines, hydroxylamines, disubstituted amines, carboxylic acids, or a combination of these groups. Amines, thiols, and alcohols are the preferred exposed functional groups for conjugation because they are both more reactive and more commonly available than other functional groups, especially in biomolecules.

Free amine groups (i.e., —NH2) are conveniently reacted with labeling reagents in which Ψ is a carboxylic acid, a derivative of a carboxylic acid, or an activated ester of a carboxylic acid, preferably a succinimidyl or sulfosuccinimidyl ester. Amine-reactive labeling reagents are particularly useful in the labeling of proteins and polypeptides, which possess free amine groups. Amine-reactive labeling reagents may also be used to label materials that have been substituted with free amine groups, such as amino-dextrans, or amine containing nucleotides, oligonucleotides, and nucleic acids.

Labeling reagents used to label analytes having free thiol groups are preferably those labeling reagents of the invention wherein Ψ is a haloalkyl, haloacetamide, halomethylbenzamide, a maleimido group, or a sulfonate ester, wherein the sulfonic acid is an alkylsulfonic acid, perfluoroalkylsulfonic acid, or an arylsulfonic acid. In some embodiments, the Ψ group may be an iodoacetamide, maleimide, or a halomethylbenzamide. Preferred alcohol- and phenol-reactive labeling reagents are those labeling reagents of the invention wherein the Ψ group is an isocyanate or an acyl nitrile.

Typically, the Ψ group is a reactive functional group that will form a covalent bond with an amine, a thiol, or an alcohol. In one embodiment, the reactive group Ψ is a carboxylic acid, an activated ester of a carboxylic acid, an acyl azide, an acyl halide, a symmetric or asymmetric anhydride, an acrylamide, an alcohol, a thiol, an aldehyde, an amine, an azide, an imido ester, a sulfonate ester, a haloacetamide, an alkyl halide, a sulfonyl halide, a hydrazine, an isocyanate, an isothiocyanate, or a maleimide group. In another embodiment, Ψ is a carboxylic acid, a succinimidyl ester, an amine, a haloacetamide, an alkyl halide, a sulfonyl halide, an isothiocyanate, or a maleimide group.

Typically, where Ψ is an activated ester of a carboxylic acid, Ψ is a succinimidyl ester. In yet another embodiment, Ψ is a reactive functional group that is an acrylamide, an activated ester of a carboxylic acid, an acyl azide, an acyl nitrile, an aldehyde, an alkyl halide, an amine, an anhydride, an aniline, an aryl halide, an azide, an aziridine, a boronate, a carboxylic acid, a diazoalkane, a haloacetamide, a hydrazine, an imido ester, an isocyanate, an isothiocyanate, a maleimide, a sulfonyl halide, or a thiol group.

In certain embodiments, the reactive group Ψ is attached to the triarylphosphonium by multiple intervening atoms, referred to herein as a “linking group,” that serve as a spacer to separate the resulting labeled substance from the triarylphosphonium itself The linking group is represented by “Z”0 in Formula I. The linking group is typically selected so as to link the triarylphosphonium to the reactive functional group Ψ with stable chemical bonds, typically including carbon-carbon bonds, carbon-nitrogen bonds, nitrogen-nitrogen bonds, carbon-oxygen bonds, and carbon-sulfur bonds. In addition to single, double, triple or aromatic carbon-carbon bonds, a lining group Z may include ether, thioether, carboxamide, sulfonamide, urea, or urethane functional moieties. Preferred Z moieties have 1-20 nonhydrogen atoms selected from the group consisting of C, N, O, and S. The longest linear segment of the linkage Z-preferably contains 1-6 nonhydrogen atoms. The linking group should be inert with respect to any intended labeling reaction.

The linking group Z may be a single methylene group (i.e., CH₂). In another embodiment, the linking group is a polymethylene, —(CR′R″₂)ₙ—, where n is 1 to 10, or 1 to 6, or 1 to 4, or 1 to 2, and where each of R′ and R″ are each independently hydrogen, a C₁-C₅ alkyl, C₂-C₅ alkenyl, C₂-C₅ alkynyl, or aryl group.

In one preferred embodiment, the phosphorous atom of the triarylphosphonium group is bonded to a methylene group, in which case the linking group may be represented by the formula —(CH₂)(CR′R″₂)ₙ—, where n is 0 to 9, or 0 to 5, or 0 to 3, or 0, and where R′ and R″ are each independently hydrogen, a C₁-C₅ alkyl, C₂-C₅ alkenyl, C₂-C₅ alkynyl, or aryl group. The labeling reagents of the invention may therefore be represented by Formulae III and IIIa (in which R′ and R″ are hydrogen):

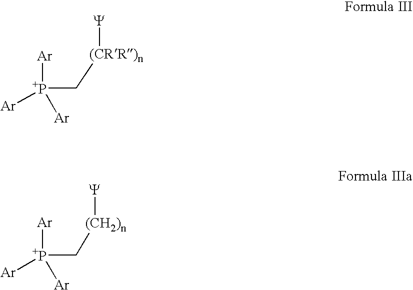

Typically, the reactive group is selected to possess suitable reactivity with a functional group already on the substance to be labeled. The reactive functional group of the labeling reagent and exposed functional group of the analyte are typically an electrophile and a nucleophile that readily react to generate a covalent linkage. Typically, but not exclusively, the reactive functional group on the labeling reagent is an electrophile, and the exposed functional group on the substance to be labeled is a nucleophile. Generally, amines, thiols, and alcohols are the preferred nucleophilic exposed functional groups for conjugation, as they are both more reactive and more commonly available for the modification of biomolecules. However, a wide variety of other functional groups, including carboxylic acids, aldehydes and ketones react under conditions well understood by one skilled in the art. Selected examples of functional groups and linkages are shown in the Table 1, below, where the reaction of an electrophilic group and a nucleophilic group yields a covalent linkage.

3.

TABLE 1
Examples of Products from the Reaction of an Electrophile -
Nucleophile Pair

| Electrophilic Group | Nucleophilic Group | Resulting Covalent Linkage |
|---|---|---|
| Activated Esters | Amines/Anilines | Carboxamides |
| Acylazides | Amines/Anilines | Carboxamides |
| Acylhalides | Amines/Anilines | Carboxamides |
| Acylhalides | Alcohols/Phenols | Esters |
| Acylnitriles | Alcohols/Phenols | Esters |
| Acylnitriles | Amines/Anilines | Carboxamides |
| Aldehydes | Amines/Anilines | Imines |
| Aldehydes/Ketones | Hydrazines | Hydrazones |
| Aldehydes/Ketones | Hydroxylamines | Oximes |
| Alkylhalides | Amines/Anilines | Alkyl Amines |
| Alkylhalides | Carboxylicacids | Esters |
| Alkylhalides | Thiols | Thioethers |
| Alkylhalides | Alcohols/Phenols | Ethers |
| Alkylsulfonates | Thiols | Thioethers |
| Alkylsulfonates | Carboxylicacids | Esters |
| Alkylsulfonates | Alcohols/Phenols | Ethers |
| Anhydrides | Alcohols/Phenols | Esters |
| Anhydrides | Amines/Anilines | Carboxamides |
| Arylhalides | Thiols | Thiophenols |
| Arylhalides | Amines | Aryl Amines |
| Aziridines | Thiols | Thioethers |
| Boronates | Glycols | Boronate Esters |
| Carboxylicacids | Amines/Anilines | Carboxamides |
| Carboxylicacids | Alcohols | Esters |
| Carboxylicacids | Hydrazines | Hydrazides |
| Carbodiimides | Carboxylicacids | N-Acylureas/Anhydrides |
| Diazoalkanes | Carboxylicacids | Esters |
| Epoxides | Thiols | Thioethers |
| Haloacetamides | Thiols | Thioethers |
| Halotriazines | Amines/Anilines | Aminotriazines |
| Halotriazines | Alcohols/Phenols | Triazinyl Ethers |
| Imidoesters | Amines/Anilines | Amidines |
| Isocyanates | Amines/Anilines | Ureas |
| Isocyanates | Alcohols/Phenols | Urethanes |
| Isothiocyanates | Amines/Anilines | Thioureas |
| Maleimides | Thiols | Thioethers |
| Phosphoramidites | Alcohols | Phosphite Esters |
| Silylhalides | Alcohols | Silyl Ethers |
| Sulfonate Esters | Amines/Anilines | Alkyl Amines |
| Sulfonate Esters | Thiols | Thioethers |
| Sulfonate Esters | Carboxylicacid | Esters |
| Sulfonate Esters | Alcohols | Ethers |
| Sulfonylhalides | Amines/Anilines | Sulfonamides |
| Sulfonylhalides | Phenols/Alcohols | Sulfonate Esters |

The specific covalent linkage that attaches the triarylphosphonium group to the analyte typically depends on the functional group that is naturally present on the analyte itself or is present as a result of derivatization of the analyte according to methods generally known in the art. In preferred aspects of the invention, the reactive functional group (Ψ) is selected from the group consisting of isothiocyanates, isothiocyanates, acyl azides, acyl nitriles, succinimidyl and thiosuccinimidyl esters, activated carboxylic acids, sulfonyl chlorides, acid chlorides, aldehydes, iodoacetamides, bromoacetamides, maleimides, aklylating reagents, disulfides, boronic acids, hydrazines, and amines.

Isothiocyanates, Isocyanates, Acyl Azides, and Acyl Nitriles. Isocyanates (—N═C═O) may deteriorate during prolonged storage. However, some acyl azides are readily converted to isocyanates upon heating 80° C. (by a Curtius rearrangement, depicted below), which react with amines to form ureas.

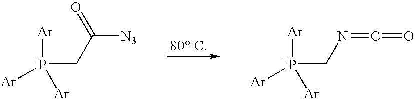

Alcohols are much easier to modify in anhydrous organic solvents than in aqueous solution. Acyl azides and acyl nitriles react directly with aliphatic amines to yield the same products as do the corresponding succinimidyl esters. However, when reacted in organic solvents, these reagents may also form derivatives of alcohols and phenols. Isocyanate and acyl azide labeling reagents of the invention include those of Formulae IV and V, below.

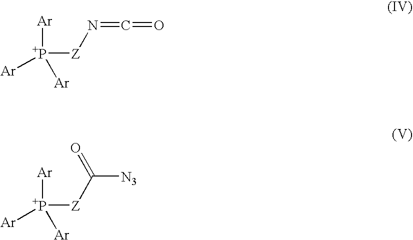

Isocyanates are much more reactive with alcohols (and amines) than are isothiocyanates. In a typical protocol, an acyl azide and alcohol are heated together in an organic solvent so that the isocyanate immediately reacts with the alcohol to form a stable urethane, depicted below.

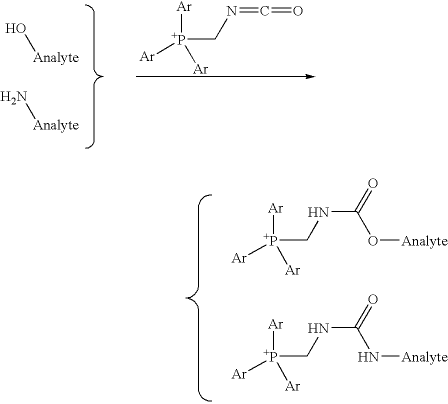

Acyl nitrites reacts with alcohols in organic solvents to yield carboxylate esters. Acyl nitrile labeling reagents of the invention include those of Formulae VI and VIa (in which Z is a methylene group), below.

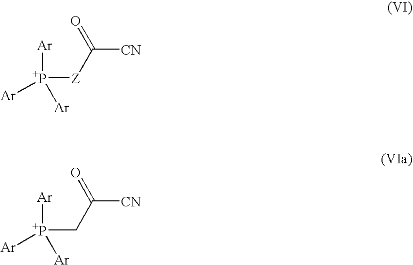

An alternative to isocyanates are isothiocyanates (—N═C═S), which are moderately reactive but more stable in water and other solvents. Isothiocyanates form thioureas upon reaction with amines, as illustrated below.

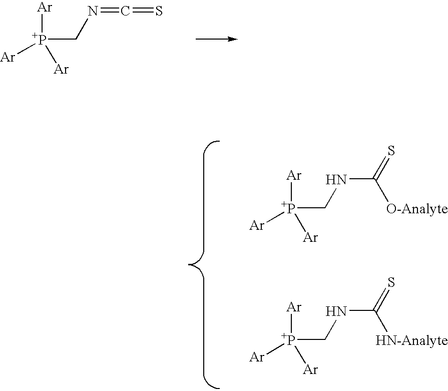

The thiourea product is reasonably stable, but generally not as stable as the products of succinimidyl esters and sulfonyl halides.

Succinimidyl and Thiosuccinimidyl Esters, Activated Carboxylic Acids. Succinimidyl (“NHS”) esters are preferred reactive groups for amine modification because the resulting amide bonds are as stable as peptide bonds. NHS ester labeling reagents of the invention have structures according to Formula VII.

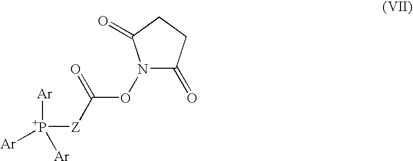

Where Ψ is a succinimidyl ester of a carboxylic acid, the reactive labeling reagent is particularly useful for preparing labeled proteins or oligonucleotides. The reagents are stable for long periods when desiccated, and they are react selectively with aliphatic amines over aromatic amines, alcohols, and phenols, as illustrated below.

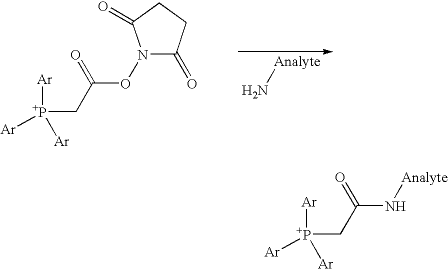

Succinimidyl esters also react with thiols to form thioesters, but such thioacyl groups may be transferred to a nearby amine (e.g., Cys→Lys in a protein). Hydrolysis of the succinimidyl ester may compete with the labeling reaction, but this side-reaction may be limited by maintaining pH≦9. Sulfosuccinimidyl (“NHSS”) esters of Formulae VIII and VIIIa, pentafluorothiophenol esters of Formula IX, and sulfotetrafluorophenol (“STP”) esters of Formulae X and Xa, depicted below, are alternatives to NHS esters that have different solubility characteristics.

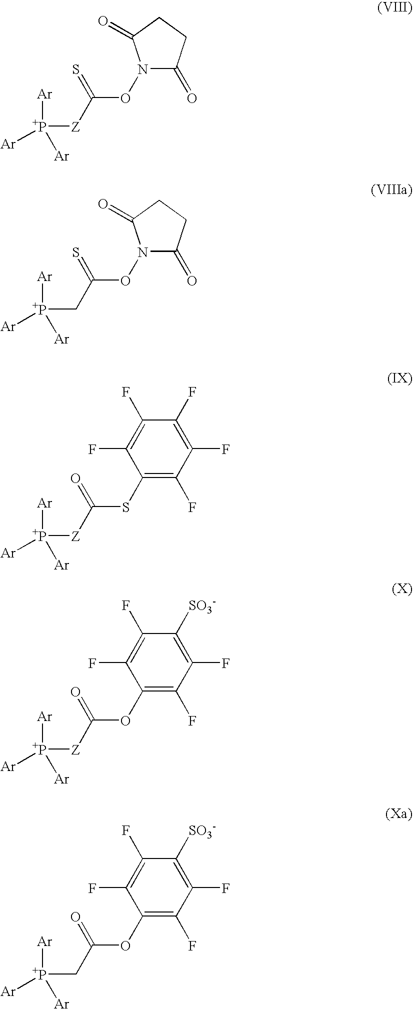

These sulfonated reagents have higher water solubility than NHS esters and may be used in media free of organic solvents. Sulfosuccinimidyl esters and STP esters may be prepared in situ from the carboxylic acid labeling reagent, a carbodiimide, and N-hydroxysulfosuccinimide or 4-sulfo-2,3,5,6-tetrafluorophenol, respectively.

The carboxylic acids may also be useful for preparing acid chlorides and anhydrides, which, unlike succinimidyl esters, are more useful for labeling aromatic amines and alcohols. Hydrazine derivatives also have amine-like reactivity and, in some cases, can be coupled to water-soluble carbodiimide-activated carboxylic acid groups.

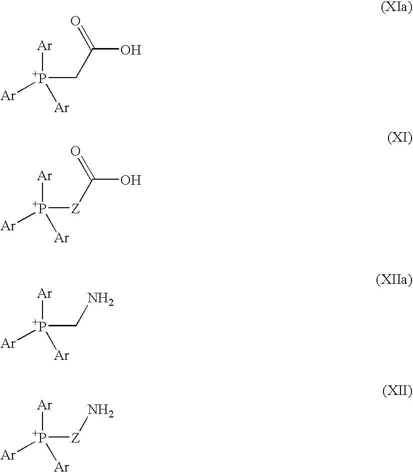

The amine and carboxylate reactive functional groups of labeling reagents according to Formulae XI, XIa, XII, and XIIa may be using in a variety of amide-bond forming methods common in the synthesis of peptides. Such methods typically employ a coupling reagent, including carbodiimides, activated anhydrides and esters, and acyl halides, for example dicyclohexylcarbodiimide, diisopropylcarbodiimide, N-ethyl-N-(3-dimethylamino-propyl)carbodiimide, DPPA, PPA, BOP reagent, N-hydroxysuccinimide, oxalyl chloride, HBTU, TBTU, HATU, HBPyU, HBPipU, PyBroP, TDBTU, TOTU, BroP, PyCloP, PyCIU, PipCIU, chloro-N, N,N′,N′-bis(tetramethylene)-formamidinium tetrafluoroborate, 2-chloro-1,3-dimethylimidazolidinium hexafluorophosphate, 2-chloro-1,3-dimethylimidazolidinium tetrafluoroborate, 1-hydroxybenzotriazole, N-ethyloxycarbony-2-ethyloxy-1,2-dihydroquinone, and propane phosphonic acid anhydride. See, e.g., P. Lloyd-Williams, et al., Tetrahedron 49, 11065-133 (1993); M. A. Gallop, et al., J. Med. Chem. 37, 1233-51 (1994); R. Schwyzer and P. Sieber, Helv. Chim. Acta 49, 134 (1966); R. B. Merrifield, J. Am. Chem. Soc. 85, 2149 (1963); B. Gutte and R. B. Merrifield, ibid. 91, 501 (1969); and U.S. Pat. Nos. 4,507,230; 5,258,454; and 6,204,361.

Typically, the amine or aniline is coupled via its free amino group to an appropriate carboxylic acid substrate using a suitable carbodiimide coupling agent, such as N,N′-dicyclohexyl carbodiimide (“DCC”), optionally in the presence of catalysts such as 1-hydroxybenzotriazole (“HOBt”), and dimethylaminopyridine (“DMAP”). Other methods include the formation of activated esters and anhydrides followed by reaction with a free amine, optionally in the presence of a base. For example, a protected Boc-amino acid or Cbz-amidino benzoic acid is treated in an anhydrous solvent in the presence of a base (e.g., N-methyl-morpholine, DMAP, or a trialkylamine) with isobutyl chloroformate to form a “activated anhydride,” which is subsequently reacted with an amine.

Sulfonyl Chlorides and Acid Chlorides. Sulfonyl chlorides of Formulae XIII and XIIIa and acid chlorides of Formulae XIV and XIVa are highly reactive and unstable in water, especially at higher pH required for reaction with aliphatic amines, and they are hydrolyzed within 2-3 minutes at pH 8.3 aqueous solution at room temperature. Accordingly, such reagents are preferably used at low temperatures. The resulting sulfonamides are usually very stable. Sulfonyl chlorides react with phenols (including tyrosine), aliphatic alcohols (including polysaccharides), thiols (such as cysteine), and imidazoles (such as histidine); however, the products are generally unstable, especially the products of reaction with aliphatic alcohols, which are subject to nucleophilic displacement. Because of their reactivity, non-nucleophilic solvents are preferred.

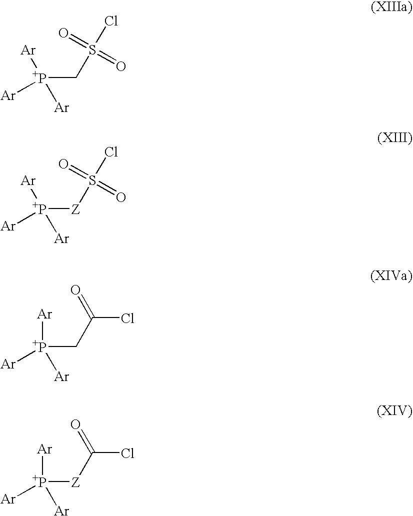

Aldehydes. Aldehyde labeling reagents of Formulae XV and XVa react with amines to form Schiff bases (e.g., Formula XVI), which may be further stabilized by reductive amination with sodium borohydride.

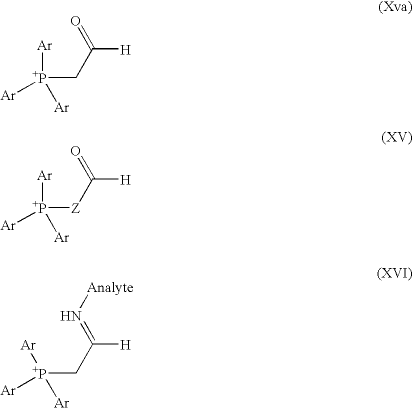

Iodoacetamides and Bromoacetamides. Iodoacetamide labeling reagents (Formula XVII, where X is an iodine atom) readily react with all thiols (including those found in peptides and proteins) to form thioethers; they are somewhat more reactive than the corresponding bromoacetamides (Formula XVII, where X is a bromine atom). Iodoacetamides and bromoacetamides may also react with histidine or tyrosine, but generally only if free thiols are absent, and they may alkylate carboxylates or alcohols.

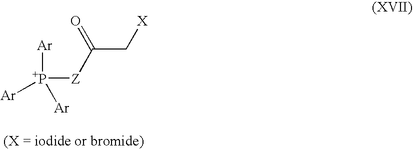

Although iodoacetamides may react with the free base form of amines, most aliphatic amines, except the N-terminus of a protein, are protonated and thus relatively unreactive below pH 8, and so the selectivity of the labeling reaction may be influenced by controlling the reaction pH. Iodoacetamides are intrinsically unstable in light, especially in solution; and labeling reactions with these reagents should therefore be carried out under reduced light conditions. Adding cysteine, glutathione, or mercaptosuccinic acid to the reaction mixture quenches the reaction of thiol-reactive labeling reagents, forming highly water-soluble adducts that are easily removed. The labeling reaction of some iodoacetamide and bromoacetamide labeling reagents of the invention with amines and thiols of analyte molecules is depicted below.

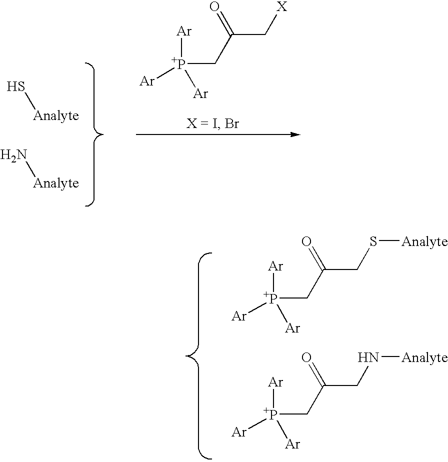

Maleimides. Where Ψ is a maleimide, the reactive labeling reagents (as in Formulae XVIII and XVIIIa) are particularly useful for conjugation to thiol-containing substances. A thiol group reacts with a maleimides by added across the double bond to form a thioether, as shown in Formula XIX. Maleimides are selective for the thiol of cysteine over methionine, histidine, or tyrosine. Reaction of maleimides with amines usually requires a higher pH than reaction of maleimides with thiols. Hydrolysis of maleimides competes significantly with thiol modification, particularly above pH 8. Furthermore, maleimide adducts can hydrolyze or ring-open by nucleophilic reaction (with an adjacent amine).

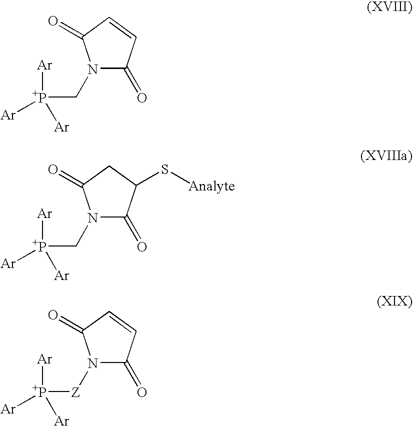

Aklylating Reagents and Disulfides. Alkyl halides and arylating agents and disulfides (typically symmetric) undergo a thiol-disulfide interchange reaction to yield a new asymmetric disulfide, a reaction that is freely reversible and is thiol-specific. The covalent adducts from these thiol-reactive labeling reagents are, in general, more resistant to hydrolysis than those from iodoacetamides or maleimides.

Boronic Acids. Boronic acid labeling reagents (as in Formulae XX and XXa) react with vicinal diols and certain amino alcohols to form cyclic complexes, as illustrated in Formulae XXI and XXII, respectively.

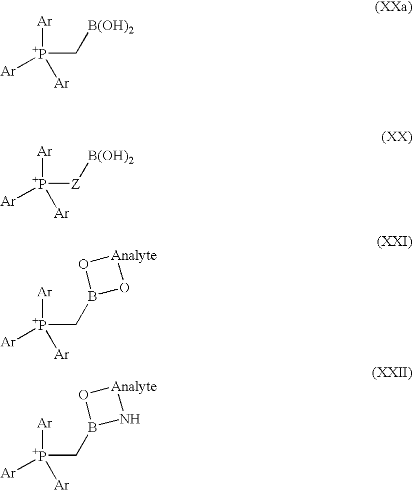

Hydrazines and Amines. Hydrazines and amines readily react with aldehydes and ketones, but these functional groups are not as common in biological samples as amines (except for polysaccharides containing free reducing sugars). Nevertheless, several methods are known for introducing aldehydes and ketones into molecules, for example, periodate-mediated oxidation of vicinal diols, or osmium tetroxide oxidation of alkenes, and oxidation by periodate to aldehydes. Periodate will also oxidize certain aminoalcohols and thiols but at a slower rate than oxidation of vicinal diols. The aldehydes and ketones thus formed may be labeled with an amine or hydrazine labeling reagent of Formulae XIII, XIIIa, XIV, and XIVa.

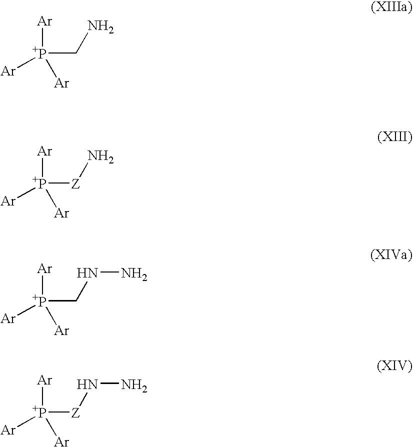

Glutaraldehyde is commonly used in the preparation of fixed tissue samples, and residual aldehyde groups (Formula XXV) may coupled to hydrazines and amines to yield products of Formula XXVI.

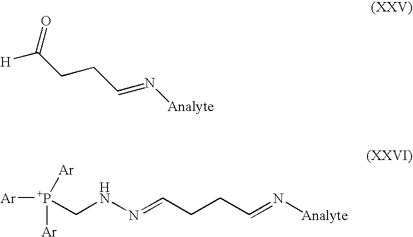

Hydrazine derivatives such as hydrazides, semicarbazides, and carbohydrazides are reactive labeling reagents for forming stable conjugates of aldehydes and ketones. Hydrazines react with ketones and aldehydes to yield stable hydrazones. These hydrazones may be reduced with sodium borohydride to further increase the stability of the linkage. Primary aliphatic and aromatic amines reversibly react with aldehydes and ketones to form Schiff bases. Because of the reversibility of the reaction, the hydrazone derivatives are usually reduced by sodium borohydride or sodium cyanoborohydride. The carboxylic acids of water-soluble compounds may also be coupled to hydrazines and amines in aqueous solution with carbodiimides, e.g., 1-ethyl-3-(3-dimethylaminopropyl)carbodiimide.

4. Synthesis of Labeling Reagents

The labeling reagents and compounds of the present invention may be readily prepared in accordance with the synthesis schemes and protocols described herein, as illustrated in the specific procedures provided. However, those skilled in the art will recognize that other synthetic pathways for forming the compounds of this invention may be used, and that the following is provided merely by way of example, and is not limiting to the present invention. See, e.g., “Comprehensive Organic Transformations” by R. Larock, VCH Publishers (1989). It will be further recognized that various protecting and deprotecting strategies will be employed that are standard in the art (See, e.g., “Protective Groups in Organic Synthesis” by Greene and Wuts). Those skilled in the relevant arts will recognize that the selection of any particular protecting group (e.g., amine and carboxyl protecting groups) will depend on the stability of the protected moiety with regards to the subsequent reaction conditions and will understand the appropriate selections.

Labeling reagents may be conveniently synthesized by alkylation of triarylphosphines, as illustrated in the following Scheme depicting nucleophilic displacement of leaving group L to yield an alkylated triarylphosphonium compound:

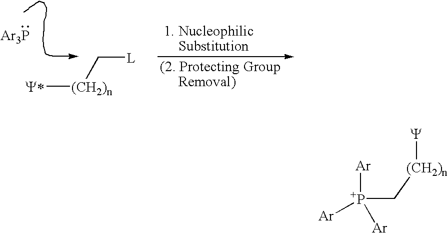

One skilled in the art will appreciate that the reactive functional group (Ψ) as such may interfere with direct alkylation of the phosphine, and therefore a synthetic precursor thereof (Ψ*) may be preferred. For example, the precursor may be a reactive functional group in which the reactive functional group is masked with a protecting group. After alkylation, the protecting group is to be removed according to any of a variety of art-recognized techniques.

The phrase “protecting group” as used herein means temporary substituents which protect a potentially reactive functional group from undesired chemical transformations. Examples of such protecting groups include esters of carboxylic acids, silyl ethers of alcohols, and acetals and ketals of aldehydes and ketones, respectively. See “Protective Groups in Organic Synthesis” 3^{rd} Ed., by T. W. Greene and P. G. M. Wuts; John Wiley & Sons, Inc., New York (1999).

The triarylphosphine may be synthesized or procured from a commercial source. Triarylphosphines are well known ligands of transition metals and are widely commercially available. Triarylphosphines are commonly synthesized by several methods: reaction of halophosphines with aryl Grignard reagents or organolithium reagents, metalation of diarylphosphines followed by reaction with aryl halides or aryl sulfonate esters, Friedel-Crafts reactions of halophosphines with activated aromatic rings, and cross-coupling of aryl halides or aryl triflates with diarylphosphines. Reactions of metalated arenes with halophosphines and Friedel-Crafts reactions are appropriate for the preparation of compounds with non-reactive aryl substituents. Cross-coupling of aryl halides or triflates with diarylphosphines to produce triarylphosphines is also known. Triarylphosphines may also be prepared by palladium-catalyzed cross-coupling of aryl halides and either (trimethylsilyl)diphenylphosphine or (trimethylstannyl)diphenyl-phosphine. Another cross-coupling reaction uses a nickel-catalyst to cross-couple a 1,1′-bi-2-naphthol disulfonate ester with diphenylphosphine to produce 2,2′-bis(diphenylphosphino)-1,1′-binaphthyl. See, e.g., U.S. Pat. Nos. 4,947,000; 4,036,889; and 5,902,904.

Commercially available (Sigma-Aldrich, Milwaukee, Wis., USA) triarylphosphines include bis(pentafluorophenyl)phenylphosphine, (4-bromophenyl)diphenylphosphine, 4-(dimethylamino)phenyldiphenylphosphine, diphenyl(2-methoxyphenyl)phosphine, diphenyl(pentafluorophenyl)phosphine, 2-(diphenylphosphino)benzaldehyde, diphenyl-2-pyridylphosphine, diphenyl(p-tolyl)phosphine, tri-2-furylphosphine, triphenylphosphine, tris(4-chlorophenyl)phosphine, tris(2,6-dimethoxyphenyl)phosphine, tris(4-fluorophenyl)-phosphine, tris(3-methoxyphenyl)phosphine, tris(4-methoxyphenyl)phosphine, tris(pentafluoro-phenyl)phosphine, tris(2,4,6-trimethoxyphenyl)phosphine, tris(2,4,6-trimethylphenyl)phosphine, 2-(diphenylphosphino)benzoic acid, 4-(diphenylphosphino)benzoic acid, 4,4′-(phenyl-phosphinidene)bis(benzenesulfonic acid), 3,3′,3″-phosphinidynetris(benzenesulfonic acid), tri-m-tolylphosphine, tri-o-tolylphosphine, and tri-p-tolylphosphine, as well as (1,2-bis(diphenyl-phosphino)benzene), and (2,2′-bis(diphenylphosphino)-1,1′-binaphthyl (S— and R-stereoisomers).

The synthesis of labeling reagents of the invention is carried out in a solvent. Suitable solvents are liquids at ambient room temperature and pressure or remain in the liquid state under the temperature and pressure conditions used in the reaction. Useful solvents are not particularly restricted provided that they do not interfere with the reaction itself (that is, they preferably are inert solvents), and they dissolve a certain amount of the reactants. Depending on the circumstances, solvents may be distilled or degassed. Non-nucleophilic solvents are preferred so that solvent alkylation does not compete with phosphine alkylation. Solvents may be, for example, aliphatic hydrocarbons (e.g., hexanes, heptanes, ligroin, petroleum ether, cyclohexane, or methylcyclohexane) and halogenated hydrocarbons (e.g., methylenechloride, chloroform, carbontetrachloride, dichloroethane, chlorobenzene, or dichlororbenzene); aromatic hydrocarbons (e.g., benzene, toluene, tetrahydronaphthalene, ethylbenzene, or xylene); ethers (e.g., diglyme, methyl-tert-butyl ether, methyl-tert-amyl ether, ethyl-tert-butyl ether, diethylether, diisopropylether, tetrahydrofuran or methyltetrahydrofurans, dioxane, dimethoxyethane, or diethyleneglycol dimethylether); nitriles (e.g., acetonitrile); ketones (e.g., acetone); esters (e.g., methyl acetate or ethyl acetate); and mixtures thereof.

In general, after completion of the reaction, the labeling reagent is isolated from the reaction mixture according to standard techniques. For example, the solvent is removed by evaporation or filtration if the product is solid, optionally under reduced pressure. After the completion of the reaction, water may be added to the residue to make the aqueous layer acidic or basic and the precipitated compound filtered, although care should be exercised when handling water-sensitive compounds. Similarly, water may be added to the reaction mixture with a hydrophobic solvent to extract the target compound. The organic layer may be washed with water, dried over anhydrous magnesium sulphate or sodium sulphate, and the solvent is evaporated to obtain the target compound. The target compound thus obtained may be purified, if necessary, e.g., by recrystallization, reprecipitation, chromatography, or by converting it to a salt by addition of an acid or base.

The synthesis of some preferred labeling reagents is depicted in the following Scheme, depicting the aklylation of isotopically-labeled tris(trimethoxyphenyl)phosphine:

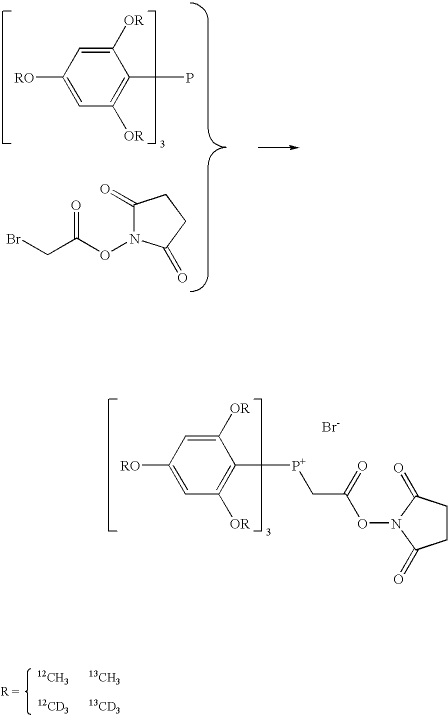

In general, the compounds of the present invention may be prepared by the methods illustrated in the general reaction schemes as, for example, described below, or by modifications thereof, using readily available starting materials, reagents and conventional synthesis procedures. In these reactions, it is also possible to make use of variants which are in themselves known, but are not mentioned here. Functional and structural equivalents of the compounds described herein and which have the same general properties (e.g., functioning as triarylphosphonium labeling reagents), wherein one or more simple variations of substituents are made which do not adversely affect the essential nature or the utility of the compound.

The chemical structures herein are drawn according to the conventional standards known in the art. Thus, where an atom, such as a carbon atom, as drawn appears to have an unsatisfied valency, then that valency is assumed to be satisfied by a hydrogen atom even though that hydrogen atom is not necessarily explicitly drawn. In addition, the compounds of the present invention may exist in unsolvated as well as solvated forms with acceptable solvents such as water, THF, ethanol, and the like. In general, the solvated forms are considered equivalent to the unsolvated forms for the purposes of the present invention.

The compounds of the invention may be supplied in a solution with an appropriate solvent or in a solvent-free form (e.g., lyophilized). In another aspect of the invention, the labeling reagents and buffers necessary for carrying out the methods of the invention may be packaged as a kit. The kit may be commercially used for labeling analytes according to the methods described herein and may include instructions for use in a method of the invention. Additional kit components may include acids, bases, buffering agents, inorganic salts, solvents, antioxidants, preservatives, or metal chelators. The additional kit components are present as pure compositions, or as aqueous or organic solutions that incorporate one or more additional kit components. Any or all of the kit components optionally further comprise buffers.

5. Mass Spectrometry Methods

A preferred mass spectrometer format for use in the invention is matrix assisted laser desorption ionization (MALDI). In other embodiments, however, other formats such as electrospray (“ES”) MS may be used. In MALDI mass spectrometry, various mass analyzers can be used, e.g., magnetic sector/magnetic deflection instruments in single or triple quadrupole mode (MS/MS), Fourier transform, and time-of-flight (TOF) configurations. For the desorption/ionization process, numerous matrix/laser combinations may be used. Ion-trap and reflectron configurations may also be employed.

Time-of-flight (TOF) mass spectrometers separate ions according to their mass-to-charge ratio by measuring the time it takes generated ions to travel to a detector. TOF mass spectrometers are advantageous because they are relatively simple, inexpensive instruments with virtually unlimited mass-to-charge ratio range. TOF mass spectrometers have potentially higher sensitivity than scanning instruments because they can record all the ions generated from each ionization event. TOF mass spectrometers are particularly useful for measuring the mass-to-charge ratio of large organic molecules where conventional magnetic field mass spectrometers lack sensitivity. See U.S. Pat. Nos. 5,045,694 and 5,160,840.

TOF mass spectrometers include an ionization source for generating ions of sample material. The ionization source contains one or more electrodes or electrostatic lenses for accelerating and properly directing the ion beam. The flight time of an ion accelerated by a given electric potential is proportional to its mass-to-charge ratio. Thus the time-of-flight of an ion is a function of its mass-to-charge ratio, and is approximately proportional to the square root of the mass-to-charge ratio. Assuming the presence of only singly charged ions, the lightest group of ions reaches the detector first and are followed by groups of successively heavier mass groups.

MALDI is particularly advantageously applied in biological applications because it facilitates desorption and ionization of large biomolecules in excess of 100,000 Da while keeping them intact. The present invention also enables the simultaneous analysis of labeled small molecules, which would otherwise be obscured by the matrix components in a MALDI experiment.

Electrospray ionization (“ESI”) is another method of ionization in addition to those described above. In electrospray ionization a syringe needle has its orifice positioned close to the entrance orifice of a mass spectrometer. A dilute solution, containing the molecules of interest, is pumped through the syringe needle. A strong electric potential, typically 3 kV to 6 kV, between the syringe needle orifice and an orifice leading to the mass analyzer forms a spray of the solution. The electrospray is carried out at atmospheric pressure and provides highly charged droplets of the solution. Ions of the molecule of interest are formed directly from the charged droplets. Since electrospray ionization occurs directly from solution at atmospheric pressure, the ions formed in this process tend to be strongly solvated. To carry out useful mass measurements, it is necessary that any solvent molecules attached to the ions be efficiently removed. Desolvation may be achieved by a strong countercurrent flow of a heated gas, before the ions enter into the vacuum of the mass analyzer. Electrospray ionization is capable of producing unfragmented ions of high molecular weight from thermally unstable or involatile biochemicals. See Dole, et al., J. Chem. Phys. 49, 2240 (1968). A solution containing the sample to be ionized is sprayed from a capillary tube into a region containing an inert gas at approximately atmospheric pressure, towards a small orifice in a plate which leads into the vacuum system of the mass spectrometer. A high electrical potential is applied between the spraying capillary and the walls of the chamber containing the inert gas (including the plate with the small orifice). See also, U.S. Pat. Nos. 4,542,293 and 4,531,056.

A time-of-flight detector is the preferred detector for measuring the desorbed and ionized analyte, and even more preferably, the time-of-flight mass analyzer is preceded by an ion reflector to correct for kinetic energy differences among ions of the same mass. Another optional enhancement of the time of flight mass analyzer is realized when there is a short, controlled, delay between the desorption and ionization of the analyte and the application of the initial acceleration voltage by the mass analyzer. Another optional embodiment of the invention uses the ion reflector to perform post source decay measurements on the desorbed, ionized, and reflected analyte. Other mass analyzers, including magnetic ion cyclotron resonance instruments, deflection instruments, and quadrupole mass analyzers are within the scope of the invention.

The triarylphosphonium group of the present invention confers upon an analyte so-labeled a fixed positive charge, which increases the sensitivity of their analysis by mass spectrometry, regardless of the particular mass spectrometry method used. In one application of the invention, molecules that are known or suspected of having different detection sensitivities are all derivatized with a labeling reagent of the invention in order to normalize their MS response.

6. Analytes and Sample Preparation

The invention pertains to methods of labeling, detecting, quantifying, locating, and analyzing various analytes. “Analyte,” as used herein is the substance to be detected and that may be present in a sample. The analyte may be a protein or a peptide; an enzyme; an immunoglobulin, including both monoclonal and polyclonal antibodies; a hapten or a bacterial, viral, parasitic, or fungal antigen; an amino acid; a hormone; a receptor; a nucleic acid; a hormone; a chemical; a polymer of biological or anthropogenic origin; a pathogen; a toxin; a saccharide or polysaccharide; a steroid; a vitamin; a therapeutic drug or a drug of abuse; a bacterium or virus; or a combination or fragment of any of the foregoing; as well as metabolites thereof and antibodies thereto.

The present invention is advantageously applied to analytes that are small molecules. A “small molecule” refers to a compound that is not itself the product of gene transcription or translation (e.g., protein, RNA, or DNA) and preferably a has a low molecular weight, e.g., less than about 1000).

Detectable analytes include, for example, those generated by the manufacture of food, industrial agents, or chemical products. Examples of such analytes include food additives (e.g., bulking agents, vitamins, colorants or flavorants), agrichemicals (such as pesticides, insecticides, herbicides, and fertilizers), surfactants (e.g., sodium dodecylsulfate), adhesives (e.g., isocyanate glues), resins (e.g., wood resins and epoxy resins), organic pollutants, and process chemicals (e.g., chemicals used in water systems) such as flocculating polymers, biocides, corrosion inhibitors, and anti-scalants. In addition, the analyte may be a substance that is used for the purpose of marking or tracing a product or process.

A “therapeutic drug” analyte is typically a drug or medicine administered for legitimate or medically-approved, therapeutic or diagnostic, purpose. Therapeutic drugs may available be over-the-counter or by prescription, Examples of therapeutic drugs include an adrenergic, anti-helmintic, anti-acne agent, anti-adrenergic, anti-allergic, anti-amebic, anti-androgen, anti-anemic, anti-anginal, anti-anxiety, anti-arthritic, anti-asthmatic, anti-atherosclerotic, antibacterial, anticholelithic, anticholelithogenic, anticholinergic, anticoagulant, anticonvulsant, antidepressant, antidiabetic, antidiarrheal, antidiuretic, antidote, anti-emetic, anti-epileptic, anti-estrogen, antifibrinolytic, antifungal, antiglaucoma agent, antihemophilic, antihemorrhagic, antihistamine, antihyperlipidemic, antihyperlipoproteinemic, antihypertensive, anti-infective, anti-inflammatory, antimalarial, antimicrobial, antimigraine, antimitotic, antimycotic, antinauseant, antineoplastic, antineutropenic, antiobessional, antiparasitic, antiparkinsonian, antiperistaltic, antipneumocystic, antiproliferative, antiprotozoal, antipruritic, antipsychotic, antirheumatic, antischistosomal, antiseborrheic, antisecretory, antispasmodic, antithrombotic, antitussive, anti-ulcerative, anti-urolithic, and antiviral agents.

Further examples of therapeutic drugs include adrenocortical steroids; adrenocortical suppressant; alcohol deterrents; aldosterone antagonists; amino acids; ammonia detoxicants; anabolic steroids; analeptic agents: analgesics; androgens; anesthetics; anorectics; appetite suppressant; benign prostatic hyperplasia therapy agents; blood glucose regulators; bone resorption inhibitors; bronchodilators; carbonic anhydrase inhibitors; cardiac depressants; cardioprotectants; cardiotonics; cardiovascular agents; cholinergic agonist and antagonists; cholinesterase deactivators or inhibitors; coccidiostatic agents; cognition adjuvants and enhancers; depressants; diagnostic aids and contrast agents; diuretics; dopaminergic agents; ectoparasiticides; emetics; enzyme inhibitors; and estrogen.

Additional examples of therapeutic drugs include fibrinolytic agents; fluorescent agents; free oxygen radical scavengers; GABA agonists; glutamate antagonists; gastrointestinal motility effectors; glucocorticoids; hair growth stimulants; hemostatic agents; histamine H2 receptor antagonists; hormones; hypocholesterolemic agents; hypoglycemic agents; hypolipidemic agents; hypotensive agents; imaging agents; immunizing agents; immunomodulators; immunoregulators; immunostimulants; immunosuppressants; impotence therapy adjuncts; keratolytic agents; LNRH agonists; monoamine oxidase inhibitor mucolytic agents; mucosal protective agents; nasal decongestants; neuromuscular blocking agents; neuroprotective agents; NMDA antagonists; AMPA antagonists, competitive and non-competitive NMDA antagonists; opioid antagonists; potassium channel openers; non-hormonal sterol derivatives; plasminogen activators; platelet activating factor antagonists; platelet aggregation inhibitors; post-stroke and post-head trauma treatments; prostaglandins; prostate growth inhibitors; psychotropics; pulmonary surface agents; radioactive agents; relaxants; scabicides; sclerosing agents; sedatives; sedative-hypnotics; selective adenosine antagonists; serotonin antagonists; serotonin inhibitors; selective serotonin uptake inhibitor; serotonin receptor antagonists; sodium and calcium channel blockers; steroids; stimulants; thyroid hormones and inhibitors; thyromimetics; tranquilizers; vasoconstrictors; vasodilators; wound healing agents; and xanthine oxidase inhibitors.

“Drug of abuse” or “street drugs” include illicit or illegal drugs. Drugs of abuse are used principally for recreational purposes or in satisfaction of an addiction, and are often self-administered or administered without the oversight of a competent healthcare provider. Drugs of abuse also include therapeutic drugs that have a high potential for addiction or abuse, such as steroids, sedatives, antidepressants, and other mood-altering drugs. Drugs of abuse may be available by prescription, but subject to abuse or addiction.

Examples of drugs of abuse include diuretics (e.g., acetazolamide, amilonde, bendroflumethiazide, bumetanide, canrenone, chlormerodrin, chlorthalidone, diclofenamide, ethacrynic acid, furosemide, hydrochlorothiazide, mersalyl, spironolactone, and triamterene), narcotic analgesics (e.g., alphaprodine, anileridine, suprenorphine, codeine, dextromoramide, dextropropoxyphene, diamorphine, dihydrocodeine, dipipanone, ethoheptazine, ethylmorphine, levorphanol, methadone, morphine, nalbuphine, pentazocine, pethidine, phenazocine, and trimeperidine), and β-blockers (e.g., acebutolol, alprenolol, atenolol, labetalol, metoprolol, nadolol, oxprenolol, propanolol, and sotalol).

Examples of drugs of abuse also include stimulants (e.g., amfepramone, amphetamine, amphetaminil, amiphenazole, benzphetamine, benzoylecgonine, caffeine, cathine, chlorphentermine, clobenzorex, clorprenaline, cocaine, cotinine, cropropamide, crotethamide, dimethamphetamine, ephedrine, etafedrine, ethamivan, etilamphetamine, fencamfamin, fenethylline, fenproporex, furfenorex, mefenorex, methamphetamine, methoxyphenamine, methylephedrine, methylenedioxymethamphetamine, methylphenidate, morazone, nicotine nikethamide, pemoline, pentetrazol, phendimetrazine, phenmetrazine, phentermine, phenylpropanolamine, pipradrol, prolintane, propylhexedrine, pyrovalerone, strychnine, and theophylline).

Further examples of drugs of abuse include hallucinogens (e.g., lysergic acid diethylamide, mescaline, phencyclidine, ketamine, dimethoxymethylamphetamine, tetrahydrocannabinol, marijuana, methylenedioxymethamphetamine), sedatives/hypnotics (e.g., chloral hydrate, glutethimide, meprobamate, and methaqualone), and anabolic steroids (e.g., bolasterone, boldenone, clostebol, dehydromethyltestosterone, fluoxymesterone, mesterolone, methandienone, methandrostenolone, methenolone, methyltestosterone, nandrolone, norethandrolone, oxandrolone, oxymesterone, oxymetholone, stanozolol, and testosterone).

Additional examples of drugs of abuse include opiates (e.g., heroin, morphine, methandone, meperidine, codeine, propoxyphene, and acetylmorphine), barbiturates (e.g., amobarbital, pentobarbital, secobarbital, phenobarbital, butalbital, and butabartial), benzodiazepines (e.g., diazepam, clorazepate, chlordiazepoxide, oxazepam, flurazepam, lorazepam, alprazolam, and triazolam), antipsychotics-antidepressants (e.g., chlorpromazinc, trazodone, haloperidol, amoxapine, lithium carbonate, doxepin, imipramine, and amitriptyline), and analgesics (e.g. acetylsalicylic acid, acetaminophen, ibuprofen, diflunisal, and phenylbutazone).

Reference to analytes that are drugs is also intended to include the various metabolites and derivatives of the native drugs, which are often the primary substances detected, due to rapid metabolism of a drug in the body. For example, the lipophilic psychoactive compound 11-nor-Δ-9-tetrahydrocannabinol of marijuana is accumulated in body tissues; however, its major metabolite, 11-nor-Δ-9-tetrahydrocannabinol carboxylic acid is excreted in the urine as a glucuronic acid conjugate at detectable levels.

Similarly, cocaine is rapidly metabolized in the body to benzoylecgonine, ecgonine methyl ester, and other minor metabolites; benzoylecgonine is detectable in the urine for a longer period of time than ecgonine methyl ester, so it is a preferred analyte for screening for cocaine use. Morphine is the major metabolite of codeine; heroin is metabolized to 6-acetylmorphine, which is further metabolized to morphine and morphine-3-glucoronide, all of which are suitable analytes according to the invention. The tricyclic antidepressants doxepin, imipramine, or amitriptyline are metabolized to the analytes nordoxepin, desipramine, and nortriptyline.

An analyte according to the present invention may also be an environmental toxin, industrial pollutant, industrial chemical, or other pollutants (e.g., amines, nitrogen heterocycles, etc.). Analytes may also be a chemical warfare agent (e.g., organophosphorous and organoarsenic compounds). Yet another application of the invention is in monitoring hazardous wastes escaping from landfills domestic, industrial, commercial, and military origin.

Any liquid suspected of containing a specific analyte can be used as a sample. The invention may also be used to detect analytes that are initially contained within solid-phase samples. These analytes would simply be extracted and suspended or dissolved in liquid prior to analysis. Solid samples may include biological tissues (obtained, for example, in the process of performing a biopsy), soil, or foliage.

In another aspect of the invention, the sample is a aqueous sample or aqueous miscible solution that is obtained directly from a liquid source, or is an aqueous suspension of a solid or semi-solid material, or is an aqueous wash from a solid or semi-solid material that is known or suspected to contain an analyte. A sample may be obtained from an environmental source such as soil, water, or air, including those from an industrial source, such as taken from a waste stream, a water source, a supply line, or a production lot. Industrial sources also include fermentation media, such as from a biological reactor or food fermentation process. Industrial sources alternatively include chemical reactors and bioreactors. Rainwater, or water from an ocean, river, lake, pond, or stream may also be a sample.

Samples of biological origin may be physiological fluids such as whole blood, plasma, serum, urine, cerebrospinal fluid, ascites fluid, sweat, lymph, or other body fluids. Alternatively, a sample may comprise fluids that are cell lysates of blood cells, cultured cells, muscle tissue, neurons and the like; extracellular fluids in areas immediately outside of cells; in vesicles; or in vascular tissue of plants and animals.

The sample may be processed, if necessary, prior to labeling and analysis. For example, the sample may be centrifuged or filtered to remove particulate matter or buffered in order to allow more efficient labeling of the analyte. As is routine in analytical and forensic science, samples may undergoes a pretreatment to remove possibly interfering components, to adjust the pH or ionic strength of the sample for optimum extraction, or simply to dilute the sample. Such pretreatment methods are well known in the art. For example, a sample may be clarified before use, such as by filtration or centrifugation. Blood product samples and urine are typically diluted with a buffer solution and may be filtered to remove proteins or particulates. For blood samples, sonication may be used to fragment cells. Proteins may be precipitated from biological samples by addition of, for example, organic solvents, perchloric or trichloroacetic acid, or metal ions; however, such precipitation may cause loss of analyte via coprecipitation. Samples may be subjected to further chemical modification, for example, the sample containing opiates are often hydrolyzed with aqueous acid.

Typically a stock solution of labeling reagent is prepared by weighing out a known mass of the pure reagent and dissolving the reagent in a solvent. The solvent should be selected so that it dissolves the labeling reagent and is unreactive. Some examples of solvents include buffered aqueous solutions, organic solvents (e.g. ethyl acetate, methanol, acetone, acetonitrile, dioxane, or tetrahydrofuran), and mixtures thereof. When a buffer is used, it should also be chosen so that it is does not react with the labeling reagent. Suitable buffers include any of those known to skilled artisans, such as a TRIS (2-amino-2-(hydroxymethyl)-1,3-propanediol). Other buffers include phosphate buffered saline (PBS), citrate buffer, or bicarbonate buffer. wherein said buffer is a member selected from the group consisting of HBS, HEPES, PBS, EGTA, and citrate buffers. For photosensitive labeling reagents, the stock solutions should be protected from light at all times. A labeling solution is prepared by diluting an aliquot of the stock solution into aqueous buffer to the desired labeling concentration. In general, the amount and concentration of labeling reagent in the labeling solution is sufficient to label all analytes, without significant background reactions. The exact amount of labeling reagent to be used is dependent upon the experimental conditions and the desired results. Optimization of experimental conditions maybe desirable to determine the best parameters to be used in a given application, which shall be readily ascertainable by the skilled artisan.

The labeling reaction conditions may be affected by temperature, pH, and changes in composition of the medium, but are readily determined using methods well-known in the art. Generally, a sample (after pretreatment, if desirable) is incubated with the labeling reagent in a reaction medium for a period of time necessary to allow the labeling reactions to occur. Under the most favorable conditions this time is less than one hour and may be as short as seconds, up to 10 minutes.

The sensitivity of the instant method permits the assays described herein to be performed in reaction mixtures of small volume. This is particularly useful for methods generally known as high-throughput screening. In one embodiment, the reaction mixture is present in the well of a microplate. In another embodiment, the reaction mixture is present on a microfluidic chip. In one aspect of the invention, the reaction mixture has a volume of less than or equal to 200 microliters.

Reactivity of Amino Groups. The amine-reactive labeling reagents include acylating reagents that form carboxamides, sulfonamides, ureas, or thioureas upon reaction with amines. The specificity and kinetics of the acylation reaction depends on the reactivity and concentration of both the acylating reagent and the amine. Buffers that contain free amines such as Tris and glycine should be avoided when using any amine-reactive labeling reagent. Residual ammonium sulfate or urea from protein sample preparation should also be removed before introducing a labeling reagent. Nucleophilic thiols may compete with the labeling reagent and therefore their concentration should also be limited.

The reactivity of an amine is principally dictated by its basicity. Most proteins have lysine residues, and most have a free amine at the N-terminus. Aliphatic amines such as the amino group of a lysine are moderately basic and reactive with most acylating reagents, but the concentration of the free base form of aliphatic amines below pH 8 is very low. Accordingly the reactions of amines with isothiocyanates, succinimidyl esters, and other acylating reagents are pH-dependent. A pH of 8.5 to 9.5 is usually preferred for modifying lysine residues, whereas a pH closer to neutral is preferred for modifying N-terminal amino group (pKa˜7), but reactions much above about pH 8.5 lead to degradation of acylation reagents in the presence of water. Protein modification by succinimidyl esters can typically be done at pH 8.5, whereas isothiocyanates usually require a pH>9 for optimal conjugations.

Aromatic amines are typically very weak bases and unprotonated at pH 7, and modification of aromatic amines may require a more reactive labeling reagent, such as an isocyanate, isothiocyanate, sulfonyl chloride, or acid halide, or a pH≧4. In aqueous media, acylating reagents are less reactive the side chain amides of glutamine and asparagine residues, the guanidinium group of arginine, the imidazolium group of histidine and the nonbasic amines, such as adenosine or guanosine (e.g., in nucleic acids).

Reactivity of Thiol Groups. Thiols (or mercaptans or sulfhydryls) are commonly found in proteins comprising cysteines, either in the native state or upon reduction of cystine disulfides with dithiothreitol or mercaptoethanol. Such disulfide reducing reagents should be removed before reaction with a thiol-reactive labeling reagent, and samples protected from air oxidation of thiols back to disulfides. Thiol-reactive functional groups include alkylating reagents, such as iodoacetamides, maleimides, and bromomethylketones, and reaction of these reagents with thiols is usually rapid at or below room temperature in the physiological pH range (pH 6.5-8.0), yielding chemically stable thioethers. Thiols may also react with amine-reactive reagents, including isothiocyanates and succinimidyl esters, but the initial products are usually unstable.

Reactivity of Hydroxy Groups. Alcohols in proteins (e.g., serine, threonine, and tyrosine), sterols, and carbohydrates are abundant in biomolecules, but are unreactive in aqueous media. Some alcohols be oxidized (e.g., with periodate) to yield aldehydes that are more readily modified with amine or hydrazine labeling reagents.

### EXAMPLES

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. The contents of all references, issued patents, and published patent applications cited throughout this application are hereby incorporated by reference. The invention is further illustrated by the following example, which should not be construed as further limiting.

As explained more fully above, qualitative and quantitative MALDI-MS analysis of small analytes (m/Z<500 Da) remains a challenge. In order to analyze small molecules, a simple and efficient coupling reaction to derivatize compounds with a large charged tag was developed. A pair of isotopically light and heavy labeling reagents (Formula XX, where R═—OC¹H₃ and —OC²H₃) was developed, adding 573 and 600 Da to each derivative, respectively. In principle, isotopic labeling of the methoxy carbon atoms is also possible. A variety of small analytes were labeled and analyzed by MALDI-MS in the low femtomole range. Tagged analytes were detected without matrix and cleanup of the reaction mixture thus enabling the systematic quantitative analysis of small molecules, amino acids, synthetic peptides, stimulants (namely amphetamine, methamphetamine, and pentermine), and other compounds (see the Drawings, appended hereto).

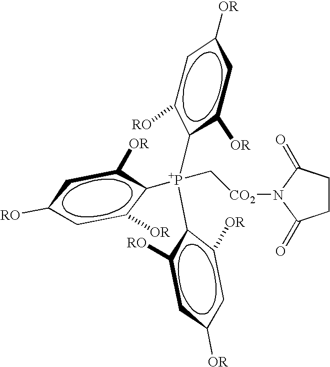

Methods and Instrumentation: Tris(2,4,6-trimethoxyphenyl)phosphonium acetic acid N-hydroxysuccinimide ester (TMPP—Ac—OSu, Formula XX) has been used in peptide sequencing. Watson, et. al., Anal. Biochem. 268, 305-17 (1999). The present invention discloses a deuterated TMPP—Ac—OSu (d27) labeling reagent, in which each methoxy group is deuterated (R═C²H₃). Activated esters containing a fixed positive charge, TMPP—Ac—Osu, and deuterated TMPP—Ac—OSu (d27) were prepared as white crystalline powders and characterized by ¹H, ¹³C, ³¹P NMR, ESI-MS, and MALDI-MS. A solution of labeling reagent (10 nmol/μL) in anhydrous acetonitrile was stored in a desiccator at room temperature for months without appreciable decomposition.

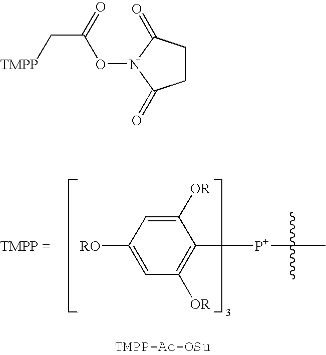

A variety of small primary and secondary amines, amino acids, synthetic peptides, and controlled substances such as amphetamine, methamphetamine and pentermine were examined. Analytes ranging from 100 to 0.1 pmol/μL in triethylaminonium bicarbonate buffer were derivatized under identical conditions and analyzed by MALDI-MS successfully. Analytes (e.g., aminomethylnaphthalene) were dissolved in triethylaminonium bicarbonate buffer with 20% CH₃CN. TMPP—Ac—OSu stock solution was prepared using anhydrous CH₃CN (10 nmol/μL). A typical labeling reaction was carried out by vortexing a mixture of 180 μL of analyte with 20 μL labeling reagent in a plastic tube for about 10 seconds, and then incubating at room temperature for about 30 minutes before adding 5 μL of 10% TFA (in 50/50% CH₃CN/EtOH), producing, e.g., labeled aminomethylnaphthalene as in Formula XX.

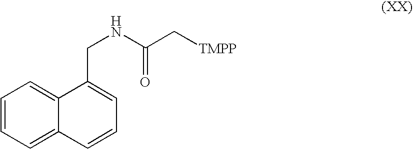

Triethylaminonium bicarbonate buffers with concentrations from 20 to 100 mM were acceptable for use in this application. A 3 to 10 molar excess of labeling reagent was sufficient to complete the coupling reaction within about 30 min. The reaction mixture was compatible with MALDI-MS analysis where labeled analytes could be analyzed directly without cleanup of the reaction mixture, even when 10,000-fold excess reagent was used. Additional evidence of compatibility of TMPP—Ac tagged molecules was observed from direct LDI-MS analysis without using matrix. The reaction mixture was spotted on a stainless steel plate (1 μL) for laser desorption ionization mass spectrometry (LDI-MS). For MALDI-MS, 10 μL of the reaction mixture and 30 μL of matrix (10 mg/mL of cyano-4-hydroxycinnamic acid in 50/50% CH₃CN/EtOH) were mixed, and 1 μL thereof was spotted onto the plate for MS analysis.

For quantitative analysis of stimulants, TMPP—Ac—OSu (d27) was coupled with a standard solution and TMPP—Ac—OSu was reacted with a spiked solution. Then equal volume of the two solutions were mixed, and 1 μL thereof was analyzed by MALDI-MS. TMPP—Ac-labeled analytes were detected by MALDI-MS as low as 1 femtomole. TMPP—Ac-labeled stimulants were quantitatively analysis by comparing the peak intensity of both light and heavy compounds.

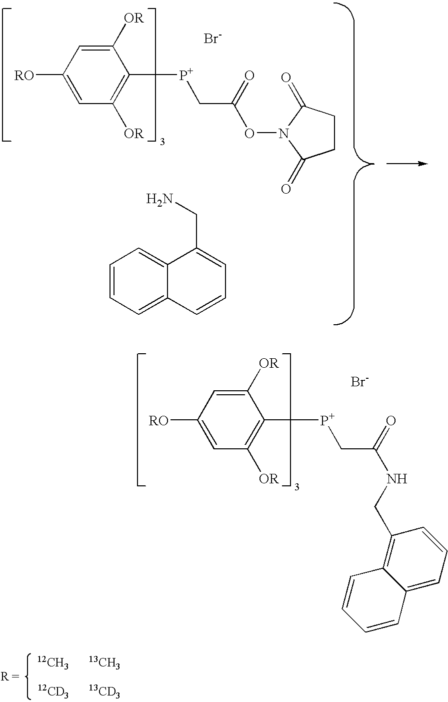

1. A method of preparing a sample for mass spectrometry analysis, comprising
a) obtaining a sample comprising an analyte, wherein said analyte comprises an exposed group; and
b) reacting said analyte with a triarylphosphonium labeling reagent having a reactive group capable of reacting with said exposed group to thereby form a triarylphosphonium-linked analyte

2. The method of claim 1, wherein the method comprises the further step of
obtaining the triarylphosphonium labeling reagent having a reactive group

3. The method according to claim 1, wherein said labeling reagent has a structure according to the formula
[Ar₃P⁺R]X⁻
wherein
each Ar is an aryl group, all of which may the same or different;
P is a phosphorous atom;
R is a reactive group comprising a functional group that reacts with said exposed group to form a covalent bond thereby forming triarylphosphonium-linked analytes; and
X⁻ is a negatively-charged counter ion.

4. A method of preparing a sample for mass spectrometry analysis, comprising
a) obtaining a sample comprising an analyte, wherein said analyte comprises an exposed group; and
b) reacting said analyte with at least two triarylphosphonium labeling reagents according to the formulae
[Ar₃P⁺R]X⁻
and
[Ar*₃P³⁰ R]X⁻
wherein
Ar and Ar* are aryl groups, all of which may the same or different, such that the molecular weight of Ar₃P is different from the molecular weight of Ar*₃P;
P is a phosphorous atom;
R is a reactive group comprising a functional group that reacts with said exposed functional group to form a covalent bond thereby forming a triarylphosphonium-linked analyte; and
X⁻ is a negatively-charged counter ion;
such that at least two triarylphosphonium-linked is analytes are formed.

5. The method of claim 4, wherein the method comprises the further step of
obtaining the at least two triarylphosphonium labeling reagents each having a reactive group, wherein the reactive groups of the labeling reagents are all the same

6. The method of claim 4, wherein the difference in the molecular weights of the triarylphosphonium groups is discernable by mass spectrometry.

7. The method of claim 4, wherein the difference in the molecular weights of the triarylphosphonium-linked analytes is discernable by mass spectrometry.

8. A method of preparing a sample for mass spectrometry analysis, comprising
a) obtaining a sample comprising an analyte, wherein said analyte comprises an exposed group; and
b) reacting said analyte with at least two labeling reagents according to the formulae
[Ar₃P⁺R]X⁻
[Ar*₃P⁺R]X⁻
[Ar**3P+R]X⁻
wherein
the Ar groups (i.e., Ar, Ar*, and Ar**, etc.) are aryl groups, all of which may the same or different, such that the molecular weights of the triarylphosphonium groups of each labeling reagent are unique;
P is a phosphorous atom;
R is a reactive group comprising a functional group that reacts with said exposed functional group to form a covalent bond thereby forming triarylphosphonium-linked analytes; and
X⁻ is a negatively-charged counter ion.

9. A method of analyzing a sample, comprising
a) obtaining a sample comprising an analyte, wherein said analyte comprises an exposed group;
forming a triarylphosphonium-linked analyte by reacting said analyte with a triarylphosphonium labeling reagent having a reactive group
that reacts with said exposed group to form a covalent bond thereby forming a triarylphosphonium-linked analyte;
such that said triarylphosphonium-linked analyte is formed; and
c) analyzing said triarylphosphonium-linked analyte by mass spectrometry.

10. The method of claim 9, wherein the method comprises the further step of
obtaining the triarylphosphonium labeling reagent having a reactive group

11. The method according to claim 10, wherein said labeling reagent has a structure according to the formula
[Ar₃P⁺R]X⁻
wherein
each Ar is an aryl group, all of which may the same or different;
P is a phosphorous atom;
R is a reactive group comprising a functional group that reacts with said exposed group to form a covalent bond thereby forming triarylphosphonium-linked analytes; and
X⁻ is a negatively-charged counter ion.

12. A method of analyzing a sample, comprising
a) obtaining a sample comprising an analyte, wherein said analyte comprises an exposed group; and
b) reacting said analyte with at least two triarylphosphonium labeling reagents according to the formulae [Ar₃P⁺R]X⁻
and
[Ar*₃P⁺R]X⁻
wherein
Ar and Ar* are aryl groups, all of which may the same or different, such that the molecular weight of Ar₃P is different from the molecular weight of Ar*₃P;
P is a phosphorous atom;
R is a reactive group comprising a functional group that reacts with said exposed functional group to form a covalent bond thereby forming a triarylphosphonium-linked analyte; and
X⁻ is a negatively-charged counter ion;
such that at least two triarylphosphonium-linked analytes are formed; and
c) analyzing said at least two triarylphosphonium-linked analytes by a mass spectrometry technique.

13. The method of claim 12, wherein the method further comprises the step of
obtaining the at least two triarylphosphonium labeling reagents each having a reactive group, wherein the reactive groups of the labeling reagents are all the same

14. (canceled)

15. The method according to claim 9, wherein said mass spectrometry technique is matrix-assisted laser desorption/ionization mass spectrometry or electrospray mass spectrometry.

16. The method according to claim 15, wherein said technique is quantitative.

17. The method of claim 13, wherein the step of reacting said analyte with at least two triarylphosphonium labeling reagents comprises
1) reacting, in a first vessel, the first labeling reagent with a first portion of said sample such that triarylphosphonium-linked analytes thereof are formed;
2) reacting, in a second vessel, the second labeling reagent with a second portion of said sample such that triarylphosphonium-linked analytes thereof are formed; and
3) combining triarylphosphonium-linked analytes from said first vessel with triarylphosphonium-linked analytes from said second vessel to form a mixture; and
wherein the step of analyzing comprises analyzing said mixture of triarylphosphonium-linked analytes by a mass spectrometry technique.

18. The method of claim 17, further comprising quantitatively comparing the relative signals of the triarylphosphonium-linked analytes from said first vessel to the triarylphosphonium-linked analytes of said second vessel.

19.-22. (canceled)

23. The method according to claim 1, wherein each Ar group is selected from the group consisting of substituted or unsubstituted aryl groups.

24. The method according to claim 1, wherein each Ar group is selected from the group consisting of substituted or unsubstituted heteroaryl groups.

25-36. (canceled)

37. The method according to claim 1, wherein said Ar₃P group is selected from the group consisting of substituted or unsubstituted triphenylphosphine, naphthyldiphenylphosphine, dinaphthylphenylphosphine, trinaphthylphosphine, 9-anthryldiphenylphosphine, 9-anthryldinaphthylphosphine, diphenylpyrenylphosphine, dinaphthylpyrenylphosphine.

38.-40. (canceled)

41. The method according to claim 1, wherein said labeling reagent has a structure according to the formula 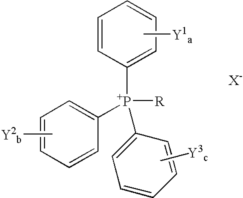
wherein
P is a phosphorous atom;
R is a reactive group comprising a functional group that reacts with said exposed functional group to form a covalent bond thereby forming triarylphosphonium-linked analytes;
a, b, and c are independently integers from 0 to 5;
Y¹, Y², and Y³, which may be the same or different, are independently selected from the group consisting of halogen, hydroxyl, alkylcarbonyloxy, arylcarbonyloxy, alkoxycarbonyloxy, aryloxycarbonyloxy, carboxylate, alkylcarbonyl, alkoxycarbonyl, aminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfate, sulfonato, sulfamoyl, sulfonamido, nitro, trifluoromethyl, cyano, azido, heterocyclyl, aralkyl, aryl, and heteroyl groups, provided that none of said Y groups reacts with said R group; and
X⁻ is a negatively-charged counter ion.

42. (canceled)

43. (canceled)

44. The method according to claim 41, wherein said labeling reagent has a structure according to the formula

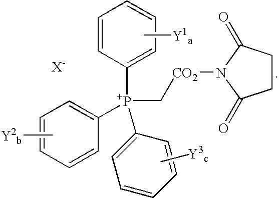

45. (canceled)

46. The method according to claim 44, wherein Y¹, Y², and Y³ are selected from the group consisting of methyl, ethyl, propyl, isopropyl, butyl, isobutyl, pentyl, hexyl, heptyl, methyloxy, ethyloxy, propyloxy, isopropyloxy, butyloxy, isobutyloxy, pentyloxy, hexyloxy, and heptyloxy.

47. (canceled)

48. The method according to claim 4, wherein each of said triarylphosphonium labeling reagents has the same chemical structure, and wherein each triarylphosphonium labeling reagent is isotopically enriched with respect to the other triarylphosphonium labeling reagent.

49. The method according to claim 48, wherein a triarylphosphonium labeling reagent is isotopically enriched with ¹²C, ¹³C, ¹H or ²H.

50. The method according to claim 41, wherein Y¹, Y², and Y³ are selected from the group consisting of O¹²C¹H₃, O¹²C²H₃, O¹³C¹ H₃, and O¹³C² H₃.

51. The method according to claim 1, wherein said exposed group of said analyte is electrophilic and said reactive functional group is nucleophilic.

52. The method according to claim 1, wherein said exposed group of said analyte is nucleophilic and said reactive functional group is electrophilic.

53.-55. (canceled)

56. The method according to claim 3, wherein X⁻ is a halide, triflate, sulfate, nitrate, hydroxide, carbonate, bicarbonate, acetate, phosphate, oxalate, cyanide, aklylcarboxylate, N-hydroxysuccinimide, N-hydroxybenzotriazole, alkoxide, thioalkoxide, alkane sulfonyloxy, halogenated alkane sulfonyloxy, arylsulfonyloxy, bisulfate, oxalate, valerate, oleate, palmitate, stearate, laurate, borate, benzoate, lactate, citrate, maleate, fumarate, succinate, tartrate, naphthylate mesylate, glucoheptonate, or lactobionate.

57. The method according to claim 3, wherein X⁻ is an anionic Y group such that the labeling reagent is zwitterionic.

58. A composition comprising at least two different labeling reagents each having a different molecular weight according to the formula
[Ar₃P⁺R]X⁻
wherein
each Ar is aryl group, all of which may the same or different;
P is a phosphorous atom;
R is a reactive group comprising a functional group that reacts with said exposed functional group to form a covalent bond thereby forming a triarylphosphonium-linked analyte; and
X⁻ is a negatively-charged counter ion.

59. A composition according to claim 58 comprising at least two different labeling reagents each having a different molecular weight according to the formula 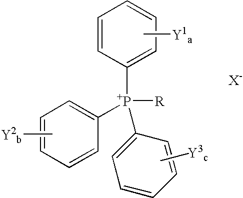
wherein
P is a phosphorous atom;
R is a reactive group comprising a functional group that reacts with said exposed functional group to form a covalent bond thereby forming triarylphosphonium-linked analytes; a, b, and c are independently integers from 0 to 5;
Y¹, Y², and Y³, which may be the same or different, are independently selected from the group consisting of halogen, hydroxyl, alkylcarbonyloxy, arylcarbonyloxy, alkoxycarbonyloxy, aryloxycarbonyloxy, carboxylate, alkylcarbonyl, alkoxycarbonyl, aminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), amidino, imino, sulflhydryl, alkylthio, arylthio, thiocarboxylate, sulfate, sulfonato, sulfamoyl, sulfonamido, nitro, trifluoromethyl, cyano, azido, heterocyclyl, aralkyl, aryl, and heteroyl groups, provided that none of said Y groups reacts with said R group; and
X⁻ is a negatively-charged counter ion.

60. The composition according to claim 59, wherein each labeling reagent has the same chemical structure, and wherein each labeling reagent is isotopically enriched with respect to the other labeling reagents.

61.-64. (canceled)

65. The method according to claim 1, wherein the labeling reagent has the following structure: 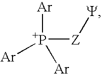
wherein
each Ar is aryl group, all of which may be the same or different;
P is a phosphorous atom;
Z is a linking group; and
Ψ is a reactive functional group.

66. The method according to claim 65, wherein said reactive functional group is an activated ester of the formula —COL, where L is a leaving group.

67.-68. (canceled)

69. The method according to claim 65, wherein said aryl groups are unsubstituted or substituted with substituents selected from the group consisting of halogens, trifluoromethyl, nitro, cyano, C₁-C₆ alkyl, C₂-C₆ alkenyl, C₂-C₆ alkynyl, C₁-C₆ alkylcarbonyloxy, arylcarbonyloxy, C₁-C₆ alkoxycarbonyloxy, aryloxycarbonyloxy, C₁-C₆ alkylcarbonyl, C₁-C₆ alkoxycarbonyl, C₁-C₆ alkoxy, C₁-C₆ alkylthio, arylthio, heterocyclyl, aralkyl, and aromatic and heteroaromatic groups.

70. The method according to claim 65, wherein said Ψ group is a carboxylic acid, a derivative of a carboxylic acid, or an activated ester of a carboxylic acid.

71. The method according to claim 65, wherein said Ψ group is a haloalkyl, haloacetamide, halomethylbenzamide, a maleimido group, or a sulfonate ester, wherein the sulfonic acid is an alkylsulfonic acid, perfluoroalkylsulfonic acid, or an arylsulfonic acid.

72. The method according to claim 65, wherein said Ψ group is an iodoacetamide, maleimide, or a halomethylbenzamide.

73. The method according to claim 65, wherein said Ψ group is an isocyanate or an acyl nitrile.

74.-76. (canceled)

77. The method according to claim 65, wherein said Ψ group is an acyl azide, an acyl nitrile, an aldehyde, an alkyl halide, an amine, an anhydride, an aniline, an aryl halide, an azide, an aziridine, a boronate, a carboxylic acid, a diazoalkane, a haloacetamide, a hydrazine, an imido ester, an isocyanate, an isothiocyanate, a maleimide, a sulfonyl halide, or a thiol group.

78. (canceled)

79. The method according to claim 65, wherein Z has 1-20 nonhydrogen atoms selected from the group consisting of C, N, O and S, and the longest linear segment contains 1-6 nonhydrogen atoms.

80.-82. (canceled)

83. The method of claim 1, wherein said analyte is a protein, peptide, enzyme, immunoglobulin, hapten, antigen, amino acid, hormone, receptor, nucleic acid, hormone, chemical, polymer, pathogen, toxin, saccharide or polysaccharide, steroid, vitamin, therapeutic drug, drug of abuse, bacterium or virus, or a combination or fragment of any of the foregoing, or a metabolite thereof, or an antibody thereto.

84. The method of claim 1, wherein said analyte is a food additive, agrichemical, surfactants, adhesives, resin, organic pollutant, or process chemical.

85. The method of claim 1, wherein said analyte is a therapeutic drug or a metabolite thereof.

86. The method of claim 1, wherein said analyte is a drug of abuse or a metabolite thereof.

87. The method of claim 1, wherein said sample is rainwater, or water from an ocean, river, lake, pond, or stream.

88. The method of claim 1, wherein said sample is a biological tissue.

89. (canceled)

90. A kit for use in preparing a sample for mass spectrometry analysis comprising a triarylphosphonium labeling reagent having a reactive group, and instructions for use in the method of the instant invention.

91. The kit according to claim 90 further comprising buffer chemicals.

92. (canceled)

93. A labeling reagent having a structure selected from the group consisting of 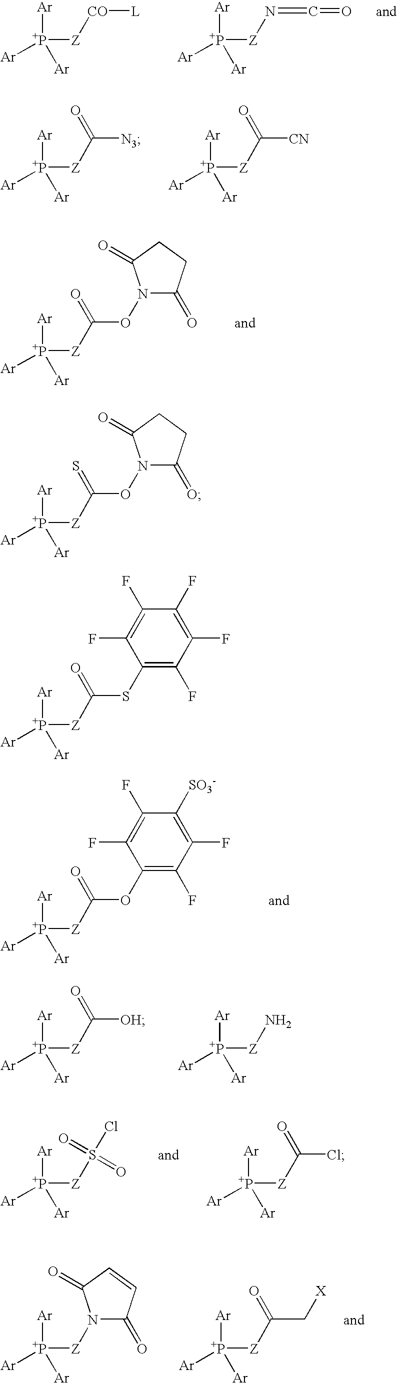 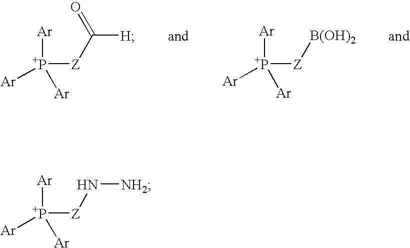
wherein
each Ar is aryl group, all of which may the same or different;
P is a phosphorous atom;
Z is a linking group; and
L and X are, independently, leaving groups.

94.-98. (canceled)
